(19) United States
(12) Patent Application Publication
(10) Pub. No.: US 2015/0088753 A1
(43) Pub. Date: Mar. 26, 2015

(54) METHOD AND APPARATUS FOR PROVIDING A VIRTUAL GIFT CARD SYSTEM

(71) Applicant: OGLOBA LTD., Hong Kong (CN)

(72) Inventor: Paul VAN DER SCHUEREN, Kraainem (BE)

(21) Appl. No.: 14/494,871

(22) Filed: Sep. 24, 2014

Related U.S. Application Data
(60) Provisional application No. 61/881,735, filed on Sep. 24, 2013.

(51) Int. Cl. G06Q 20/34; G06Q 20/36; G06Q 20/40; G06Q 20/38

(52) U.S. Cl. CPC G06Q 20/351; G06Q 20/382; G06Q 20/36; G06Q 20/342; G06Q 20/4012
USPC 705/67

(57) ABSTRACT

An approach is provided for linking one or more virtual gift cards to the wallet database associated with the unique identifier of at least one mobile device. The approach involves receiving a request for registering a virtual gift card to a mobile device, wherein the request specifies a unique identifier associated with the mobile device. The approach also involves determining a card identifier associated with the virtual gift card. The approach further involves generating a card token for the virtual gift card based on the card identifier. The approach also involves storing the card token in a wallet database, wherein the wallet database is associated with the unique identifier of the mobile device, and wherein the wallet database is accessed from an application of the mobile device.

### RELATED APPLICATIONS

This application claims the benefit of the earlier filing date under 35 U.S.C. §119(e) of U.S. Provisional Application Ser. No. 61/881,735 filed Sep. 24, 2013, entitled “METHOD AND APPARATUS FOR PROVIDING A GIFT CARD SYSTEM,” the entirety of which is incorporated herein by reference.

### BACKGROUND

Traditionally, gift cards have been made available as physical objects (e.g., physical cards). The disadvantages of such conventional gift cards are that the users have to physically carry and present the card while making a purchase, and if the card is lost a replacement is generally unavailable. Alternatively, with the advances in electronic commerce and communications technology, virtual gift cards are gaining popularity because it resolves the issues encountered in physical gift cards. As a result, service providers are continually challenged to deliver value and convenience to consumers, by, for example, providing a system for managing the use, access, and interoperability of physical and virtual gift cards within a closed loop system.

### BRIEF DESCRIPTION OF THE DRAWINGS

The embodiments of the invention are illustrated by way of example, and not by way of limitation, in the figures of the accompanying drawings:

FIG. 1 is a diagram for linking one or more virtual gift cards to the wallet database associated with the unique identifier of at least one mobile device, according to one embodiment;

FIG. 2 is a diagram of components of the transaction platform 109, according to one embodiment;

FIG. 3 is a flowchart of a process for generating a card token for a virtual gift card and storing the card token in a wallet database, according to one embodiment;

FIG. 4 is a flowchart of a process for initiating the activation of the mobile application to access the wallet database, according to one embodiment;

FIG. 5 is a flowchart of a process for validating a virtual gift card and updating the wallet database based on the validation response, according to one embodiment;

FIG. 6 is a flowchart of a process for sharing or sending a virtual gift card to another mobile device, according to one embodiment;

FIG. 7 is a ladder diagram utilized in the process of registering and creating a wallet linked to a MSISDN number of at least one mobile device, according to one embodiment;

FIG. 8 is a ladder diagram utilized in the process of refreshing the mobile device application, according to one embodiment;

FIG. 9 is a ladder diagram utilized in the process of activating at least one virtual gift card, according to one embodiment;

FIG. 10 is a ladder diagram utilized in the process of importing a physical gift card as a virtual gift card on a wallet associated with the MSISDN number of a mobile device, according to one embodiment;

FIG. 11 is a ladder diagram utilized in the virtual gift card redemption process, according to one embodiment;

FIG. 12 is a ladder diagram utilized in the process of reloading one or more virtual gift cards, according to one embodiment;

FIG. 13 is a ladder diagram utilized in the process of importing a sent email or a shared gift card to the receiver's MSISDN wallet, according to one embodiment;

FIG. 14 is a ladder diagram utilized in the process of sending or sharing a virtual gift card, according to one embodiment;

FIG. 15A is a ladder diagram utilized in the process of importing a sent or shared virtual gift card to the receiver's wallet database associated with the MSISDN number of the at least one mobile device, according to one embodiment;

FIG. 15B is a user interface diagram utilized in the process of linking a social media service application to a VGC App, according to one embodiment;

FIG. 16 is a flowchart of a process utilized in the functioning of the virtual gift cards in a wallet database, according to one embodiment;

FIGS. 17A-17I are diagrams of user interfaces utilized in the processes of FIGS. 3-6, according to various embodiments;

FIG. 18 is a diagram of hardware that can be used to implement an embodiment of the invention;

FIG. 19 is a diagram of a chip set that can be used to implement an embodiment of the invention; and

FIG. 20 is a diagram of a mobile terminal (e.g., handset) that can be used to implement an embodiment of the invention.

### DESCRIPTION OF SOME EMBODIMENTS

A method, apparatus, and software for linking one or more virtual gift cards to the wallet database associated with the unique identifier of at least one mobile device are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Gift cards have grown in popularity because of the convenience, and the security concerns associated with cash. Gift cards are generally received from a third-party and are associated with certain retailers or service providers. As used herein, a “gift card” refers to either a physical card (for example, a paper card with bar code, a plastic card with bar code or magnetic stripe, and a web pin code) or a virtual card that is associated with a monetary value that can be used to purchase or otherwise acquire products or services from a third-party. Such cards may also be in the form of closed-loop cards issued by a third-party. In one embodiment, a complete closed-loop gift card may have a unique card number and an International Article Number (EAN13) item code separately, or embedded in, the same EAN128 code. It is noted that although various embodiments are described here with respect to EAN13 and EAN128 codes, it is contemplated that the approaches described herein are applicable to any barcode standard or other standard for generating unique product identifiers used in commerce.

One traditional concern associated with gift cards is the need for consumers to carry the physical gift cards in order to user them. As a result, consumers may often find themselves in situations where they may want to use a gift card but find that they do not have current access to them. At the same time it is noted that with the popularity of mobile devices (e.g., smartphones, tablets, portable computers, etc.) increasing, users are more likely to carry their mobile devices than their gift cards. Therefore, to improve user experience with respect to gift cards, the system 100 introduces various methods for providing a gift card system that enables users to manage or otherwise use both physical and virtual gift cards in combination with mobile connected devices. In one embodiment, the system 100 enables virtual gift cards to be delivered via SMS and/or e-mail to a recipient, the benefits being that the delivered cards cannot be lost and that the consumer does not have to drive to a certain location to purchase a gift card. In one scenario, a physical gift card may be converted into a virtual gift card using a mobile device application as described herein. In another embodiment, a dummy plastic card with an EAN13 or other barcode/product identifier may be used to trigger the request for a virtual gift card. In a further embodiment, a mobile device application may be available to access virtual gift cards, whereby the users of the mobile devices may download a dedicated application to access the virtual gift cards. The mobile device applications may provide a wallet of all the cards linked to the MSISDN number in the system, and such data may be saved in a database for reference purposes. Although various embodiments are discussed with MSISDN as an example of a device identifier, it is contemplated that the various embodiments described herein are also applicable to any unique identifier associated with a user device.

In one embodiment, one or more users may download a mobile device application via their respective mobile devices through the communication network to perform all or a portion of the functions of the system described herein. Then, the users may enter their respective MSISDN number to create a wallet of cards linked to their respective MSISDN number. Subsequently, a token may be issued and sent by short message service (SMS) to the MSISDN number. The token must be entered to activate the wallet. In one embodiment, the card wallet is accessible with the mobile device application via a communication network, wherein the user enters the MSISDN number of the account, and then enters the security token sent to the registered MSISDN number. In another embodiment, the database of linked cards may include data elements such as: (1) an alias short number associated with a card number associated with a gift card; (2) one or more beneficiaries' MSISDN or other device identifier; (3) one or more social network beneficiaries credentials; and (4) so on. In a further embodiment, mobile card details are automatically updated in the database after refreshing an electronic wallet via a communication network.

In one embodiment, the system 100 may link the virtual gift cards to the MSISDN number and may automatically add the virtual gift card to the corresponding wallet on the mobile device application after a retailer and/or merchant (the terms, retailer and merchant, are used interchangeably to refer to an entity that offers goods and/or services) operating a point-of-sale (POS) terminal in a store where the physical cards are sold, may request and key in the MSISDN number of the consumer during the activation process. Consequently, the mobile cards may be displayed on the mobile device application for usage. In one embodiment, the mobile device application may provide on demand a screen display of the balance of the virtual gift card, card detail, card transaction with amount, time and location where the money has been spent, and a bar code for transactions at a POS terminal, or a combination thereof. In addition, activation and/or redemption and/or reload and/or send and/or sharing of transactions are accessible in real time, directly from the mobile device application.

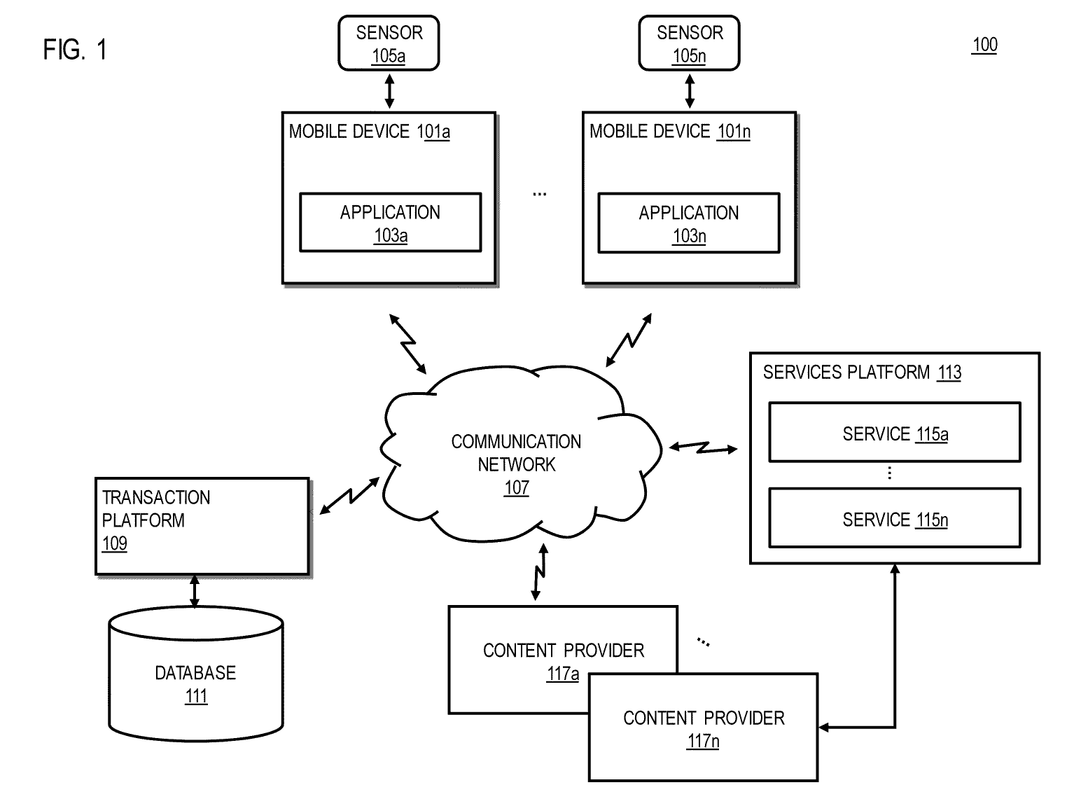

As shown in FIG. 1, the system 100 comprises mobile device 101a-101n (collectively referred to as mobile device 101) that may include or be associated with applications 103a-103n (collectively referred to as applications 103), and sensors 105a-105n (collectively referred to as sensors 105). In one embodiment, the mobile device 101 has connectivity to the transaction platform 109 via the communication network 107.

By way of example, the mobile device 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the mobile device 101 can support any type of interface to the user (such as “wearable” circuitry, etc.).

By way of example, the applications 103 may be any type of application that may perform various processes and/or functions at the mobile device 101. In one embodiment, the applications 103 may be content (e.g., audio, video, images, etc.) provisioning applications, social networking applications, token assigning applications, location-based service applications, sensor monitoring applications, calendar applications, camera/imaging application, media player applications, social networking applications, and the like etc. In one embodiment, one of the applications 103 at the mobile device 101 may act as a client for the transaction platform 109 and perform one or more functions associated with the functions of the transaction platform 109.

By way of example, the sensors 105 may be any type of sensor. In certain embodiments, the sensors 105 may include, for example, a network detection sensor for detecting wireless signals or receivers for different short-range communications (e.g., Wi-Fi, Bluetooth, Infrared, Near Field Communication (NFC) etc.), temporal information sensors, a camera/imaging sensor for gathering image data, an audio recorder for gathering audio data, a global positioning sensor for gathering location data (e.g., GPS), and the like.

The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

In one embodiment, the transaction platform 109 may be a platform with multiple interconnected components. The transaction platform 109 may include multiple servers, intelligent networking devices, computing devices, components and corresponding software for linking one or more virtual gift cards to the wallet database associated with the unique identifier of at least one mobile device. In one scenario, one or more users may download an application in at least one mobile device for registering and creating one or more virtual gift cards. Then, the transaction platform 109 may receive the MSISDN number, user identification information, or a combination thereof for linking one or more virtual gift cards to the MSISDN number associated with at least one mobile device. Subsequently, the transaction platform 109 may provide registration token for activating the linked virtual gift card to the MSISDN wallet.

In one embodiment, the transaction platform 109 may cause an addition of the one or more virtual gift cards to the corresponding MSISDN wallet based, at least in part, on a request from a cashier operating a point-of-sale (POS) terminal. The request involve the cashier entering the MSISDN number, scanning the bar code of the virtual gift card, swiping the magnetic stripe of the paper gift card, or a combination thereof. In another embodiment, the transaction platform 109 may cause a transmission of information from at least one POS terminal to the front server to authorize an activation of a virtual gift card transaction. Subsequently, the transaction platform 109 may cause a collection of an amount corresponding to the activation based, at least in part, on the response from the front end server.

In one embodiment, the transaction platform 109 may import one or more physical gift cards as the virtual gift cards on the MSISDN wallet. Then, the transaction platform 109 may cause a creation of one or more new card numbers with security digits, one or more new corresponding bar codes, or a combination thereof. The virtual gift cards with the new card number may be linked to several MSISDN wallets. In one scenario, the POS terminal operator may select a redemption transaction, a reload transaction, or a combination thereof. Then, the transaction platform 109 may cause a transmission of information by the POS terminal to the front server to authorize the redemption transaction, the reload transaction, or a combination thereof. Subsequently, the transaction platform 109 may authorize the redemption transaction, the reload transaction, or a combination thereof based, at least in part, on the response from the front server.

In one embodiment, the transaction platform 109 may share or send at least one virtual gift card between at least one user, at least one other user, or a combination thereof. The transaction platform 109 may cause a de-activation of the redemption transaction, the reload transaction, or a combination thereof from the MSISDN wallet of the at least one user sending the virtual gift card. In another embodiment, the transaction platform 109 may cause a presentation of the virtual gift card information in at least one mobile device. In one scenario, the virtual gift card information includes balance information, transaction information, temporal information, contextual information, or a combination thereof.

In one embodiment, the transaction platform 109 may include or have access to a database 111 to access or store any kind of data, such as token information, virtual gift card information, historical user information, user activity information, contextual information etc. Data stored in the database 111 may, for instance, be provided by the mobile device 101, a service platform 113, one or more services 115a-115n (or services 115), or one or more content providers 117a-117n (or content providers 117). In one embodiment, the database 111 may include an index for tokens, virtual gift cards, etc. and the transaction platform 109 may query the index based, at least in part, on a provided input, such as, from interacting with applications 103 via the mobile device 101.

In one embodiment, the services platform 113 may include any type of service. By way of example, the services platform 113 may include social networking services, content (e.g., text, images, etc.) provisioning services, application services, storage services, contextual information determination services, location based services, information (e.g., time etc.) based services, etc. In one embodiment, the services platform 113 may interact with the mobile device 101, the transaction platform 109 and the content providers 117 to supplement or aid in the processing of the content information.

In one embodiment, services 115 may be an online service that reflects the interests and/or activities of its users. In one scenario, the services 115 provide representations of each user (e.g., a profile), his/her social links, and a variety of additional information. The services 115 allow users to share activities information, contextual information, historical user information and interests within their individual networks, and provides for data portability. In one embodiment, information on virtual gift cards may be shared or transmitted via services 115.

The content providers 117 may provide content to the mobile device 101, the transaction platform 109, and the services 115 of the services platform 113. The content provided may be any type of content, such as textual content, image content, video content, etc. In one embodiment, the content providers 117 may provide content that may supplement content of the applications 103, sensors 105, or a combination thereof. In one embodiment, the content providers 117 may also store content associated with the mobile device 101, the transaction platform 109, and the services 115 of the services platform 113. In one embodiment, the content providers 117 may manage access to a central repository of data, and offer a consistent, standard interface to data.

By way of example, the mobile device 101, the transaction platform 109, the services platform 113, and the content providers 117 communicate with each other and other components of the communication network 107 using well known, new, or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software applications executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

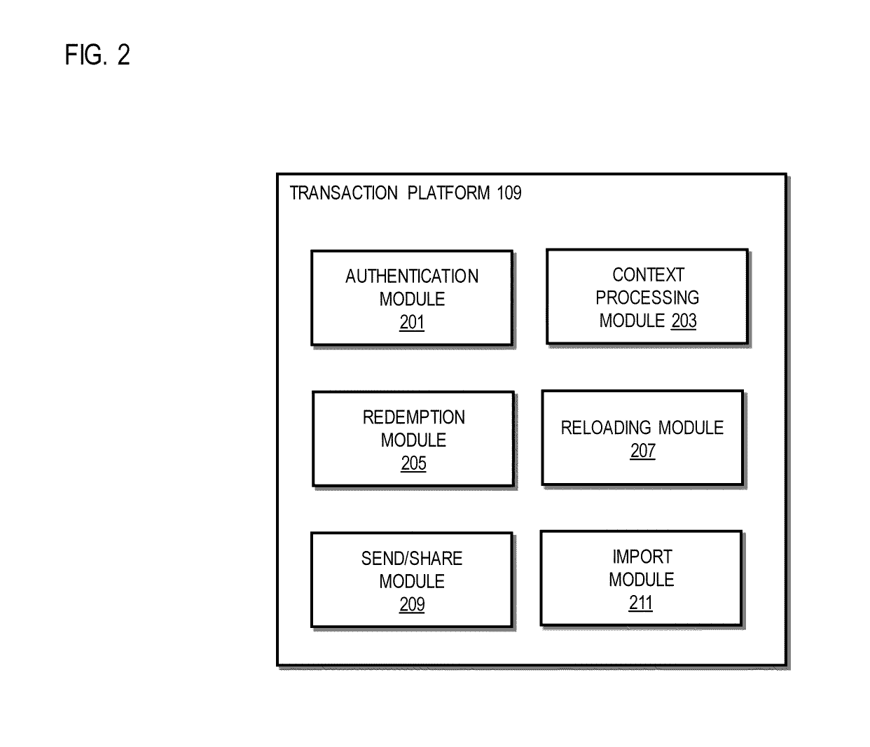

FIG. 2 is a diagram of the components of the transaction platform 109, according to one embodiment. By way of example, the transaction platform 109 includes one or more components for linking one or more virtual gift cards to the wallet database associated with the unique identifier of at least one mobile device, according to one embodiment. In this embodiment, the transaction platform 109 includes an authentication module 201, context processing module 203, redemption module 205, reloading module 207, send/share module 209 and import module 211. It is contemplated that the functions of these components may be combined in one or more components or performed by other components of equivalent functionality.

In one embodiment, an authentication module 201 authenticates users and mobile device 101 for linking one or more virtual gift cards to the MSISDN number. The authentication process performed by the authentication module 201 may include one or more users downloading a mobile application in their respective mobile device 101, and then entering their MSISDN number to create a wallet of cards linked to their mobile device 101. The authentication module 201 may receive and validate a login token as provided or established for a particular user during a registration process. In one scenario, the login process may be performed through an automated association of profile settings maintained with an IP address, a carrier detection signal of a mobile device 101, mobile directory number (MDN), subscriber identity module (SIM) (e.g., of a SIM card), or other identifier. In another embodiment, the authentication module 201 may cause a transmission of information from at least one POS terminal to the front server to authorize an activation of a virtual gift card transaction. In a similar manner, the authentication module 201 may authorize redemption, reload, or a combination thereof of a virtual gift card transaction.

In one embodiment, the context processing module 203 may receive contextual information as gathered by the sensors 105 of the respective mobile device 101. Once received, the context processing module 203 may analyze the contextual information to link one or more virtual gift cards to the MSISDN number associated with at least one mobile device.

In one embodiment, the redemption module 205 may cause redemption of amount in at least one virtual gift card at any POS terminal integrated into the system for payment of the purchased items. In one scenario, the POS terminal operator selects a redemption transaction, wherein the POS operator inputs the amount to be redeemed. Then, the POS terminal operator may scan the bar code or the magnetic stripe of the virtual gift card, whereby the POS terminal sends information message to the redemption module 205. In one embodiment, the redemption module 205 may co-ordinate with the authentication module 201 to control the card and send a positive or negative response to the redemption request.

In one embodiment, the reloading module 207 may cause a reloading of one or more virtual gift cards. In one embodiment, the POS terminal operator selects an application to reload at least one virtual gift card, whereby the POS terminal operator may scan the bar code of the mobile device 101, the card, or swipes the magnetic stripe of the card. Thereafter, the POS terminal may send information to the reloading module 207. In one embodiment, the reloading module 207 may co-ordinate with the authentication module 201 to control the card and send a positive or a negative response to the reload request.

In one embodiment, the send/share module 209 allows holders to send or share their virtual gift cards with the users of other mobile device 101. In one embodiment, the send/share module 209 allows the virtual gift cards to be shared wherein the virtual gift card may remain in the sender's wallet in the mobile device 101 and may be used by all holders. In another embodiment, if a virtual gift card is sent, redeem and reload functions are deactivated from the sender's wallet and the virtual gift card can only be used by the receiver. In one scenario, virtual gift cards may be shared by a cardholder with one or more family members. In one embodiment, the send/share module 209 may allow the virtual gift cards to be sent or shared via SMS or email. In one scenario, when a card holder sends or shares a virtual gift card, the send/share module 209 allows the card holders to write a message and/or upload a picture or a video which may be sent alongside the virtual gift card when the recipient receives it in his MSISDN wallet on the mobile application. In another scenario, the one or more virtual gift cards may come with a link of one or more photos and/or videos and/or audios attached to it, for instance, B2B cards sent by a corporate entity to the mobile phones of its employee with a video of the CEO.

In one embodiment, the import module 211 may allow the physical gift cards to be directly imported after activation by linking the physical gift card to the MSISDN number of that wallet. In another embodiment, the import module 211 may cause an import of the physical gift cards by entering card number as well as the web pin code of the card in the mobile application.

The above presented modules and components of the transaction platform 109 can be implemented in hardware, firmware, software, or a combination thereof. Though depicted as a separate entity in FIG. 1, it is contemplated that the transaction platform 109 may be implemented for direct operation by the respective mobile device 101. As such, the transaction platform 109 may generate direct signal inputs by way of the operating system of the mobile device 101 for interacting with the applications 103. In another embodiment, one or more of the modules 201-211 may be implemented for operation by the respective mobile device 101, the transaction platform 109, or a combination thereof. Still further, the transaction platform 109 may be integrated for direct operation with services 115, such as in the form of a widget or applet, in accordance with an information and/or subscriber sharing arrangement. The various executions presented herein contemplate any and all arrangements and models.

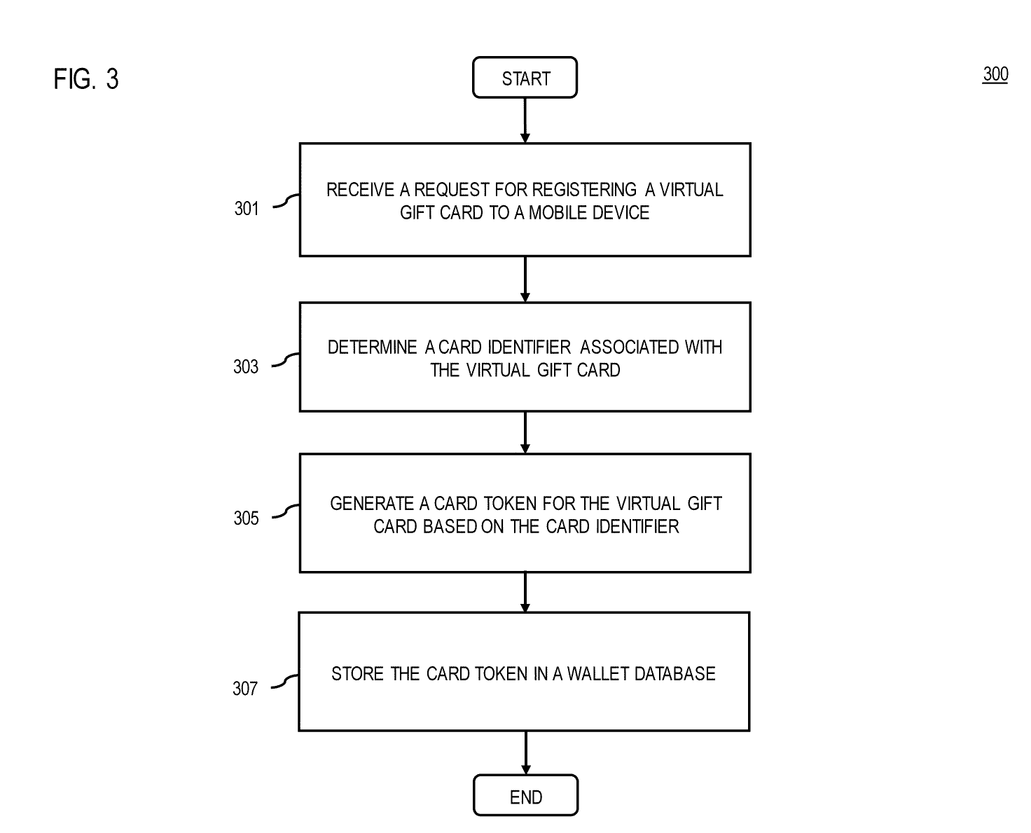

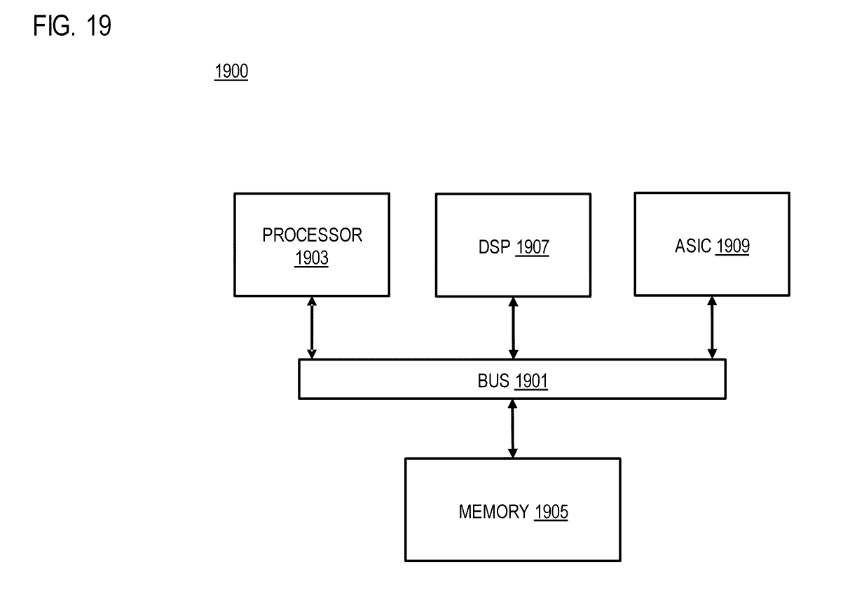

FIG. 3 is a flowchart of a process for generating a card token for a virtual gift card and storing the card token in a wallet database, according to one embodiment. In one embodiment, the transaction platform 109 performs the process 300 and is implemented in, for instance, a chip set including a processor and a memory as shown in FIG. 19.

In step 301, the transaction platform 109 receives a request for registering a virtual gift card to a mobile device, wherein the request specifies a unique identifier associated with the mobile device. In one embodiment, the unique identifier associated with the mobile device is a MSISDN number. In one example embodiment, one or more users may download a mobile application in their mobile device 101. Then, the user may enter their MSISDN number to create a wallet to link one or more virtual gift cards. In one scenario, virtual gift cards may include a paper gift card with a bar code, a plastic gift card with a bar code or a magnetic stripe, a computer-generated gift card with a bar code, or a combination thereof.

In step 303, the transaction platform 109 determines a card identifier associated with the virtual gift card. In one embodiment, the card identifier associated with the virtual gift card is an EAN-13 barcode. In one example embodiment, one or more gift cards may be equipped with a special barcode, generally in the EAN-13 format, to facilitate their processing.

In step 305, the transaction platform 109 generates a card token for the virtual gift card based on the card identifier. In one scenario, the transaction platform 109 may issue a token for a virtual gift card. The transaction platform 109 may send the token to the MSISDN number via SMS. The receive token must be entered to activate the wallet.

In step 307, the transaction platform 109 stores the card token in a wallet database. In one embodiment, the wallet database is associated with the unique identifier of the mobile device. In another embodiment, the wallet database is accessed from an application of the mobile device. In one scenario, the mobile application provides a wallet to store one or more virtual gift cards linked to one MSISDN number. In one scenario, one or more gift cards in the wallet database may be associated with an alias short number, one or more beneficiaries' MSISDN and one or more social network beneficiaries' credentials.

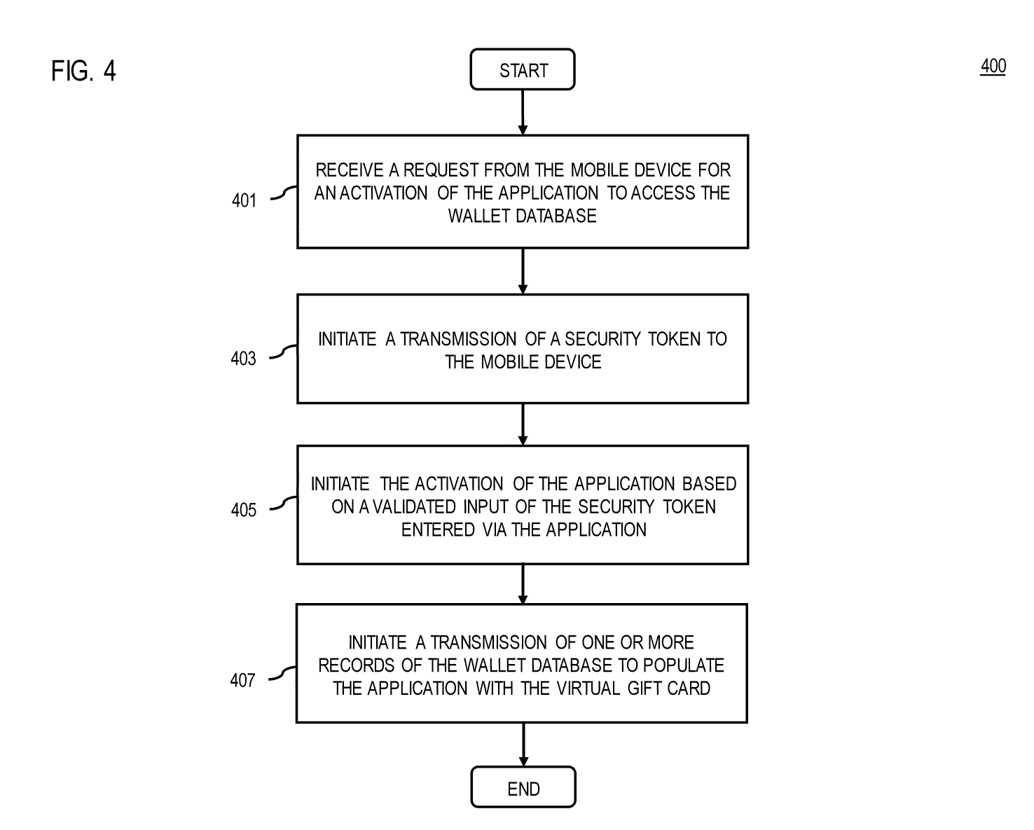

FIG. 4 is a flowchart of a process for initiating the activation of the mobile application to access the wallet database, according to one embodiment. In one embodiment, the transaction platform 109 performs the process 400 and is implemented in, for instance, a chip set including a processor and a memory as shown in FIG. 19.

In step 401, the transaction platform 109 receives a request from the mobile device for an activation of the application to access the wallet database, wherein the request specifies the unique identifier. In one scenario, a user may download a virtual gift card (VGC) application in his/her mobile device 101. Then, the user may provide contextual information and send a registration request. The user may receive a registration response with a token. Subsequently, the user may enter the token to activate the mobile application for accessing the wallet database for all cards linked to the one MSISDN number.

In step 403, the transaction platform 109 initiates a transmission of a security token to the mobile device. In one scenario, the user of a mobile device 101 may receive a token for activating the feature of adding virtual gift cards to the wallet database. In one example embodiment, the wallet database stores the monetary value of one or more virtual gift cards, and enables a transaction (e.g., transfer of the value of the virtual gift cards from the buyer to the vendor) via a mobile device 101.

In step 405, the transaction platform 109 initiates the activation of the application based on a validated input of the security token entered via the application. In one scenario, the wallet database is accessible via mobile application downloaded in a mobile device 101. The user may enter their MSISDN number, and then enter their security token sent to the registered MSISDN number.

In step 407, the transaction platform 109 initiates a transmission of one or more records of the wallet database to populate the application with the virtual gift card. In one embodiment, the one or more records include information associated with the virtual gift card, the card identifier, the card token, or a combination thereof. In one scenario, the information associated with virtual gift card includes card balance information, card transaction information, date, time and place of transaction, etc. In another scenario, the card identifier information may include barcode information for card identification (e.g., EAN-13). In a further scenario, the card token information may include a code, a personal identification number (PIN), etc.

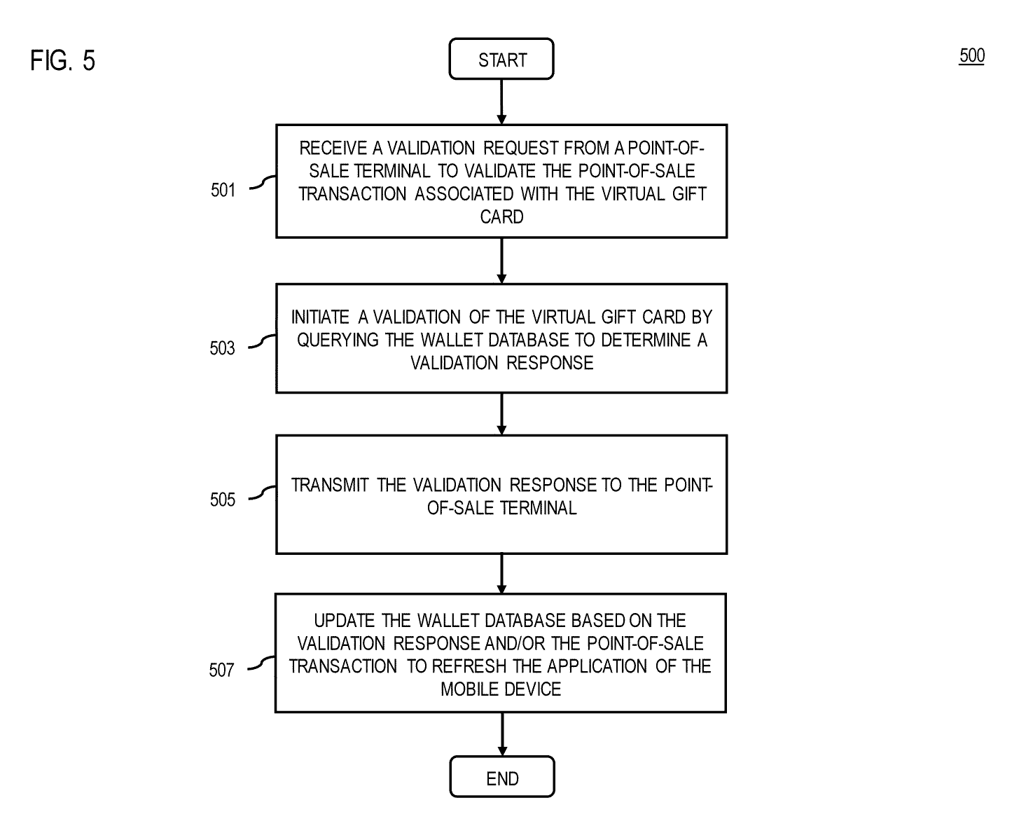

FIG. 5 is a flowchart of a process for validating a virtual gift card and updating the wallet database based on the validation response, according to one embodiment. In one embodiment, the transaction platform 109 performs the process 500 and is implemented in, for instance, a chip set including a processor and a memory as shown in FIG. 19.

In step 501, the transaction platform 109 may receive a request for registering the virtual gift card by at least one of (a) scanning of a physical gift card, (b) a point-of-sale transaction, (c) an input for specifying the virtual gift card, the product identifier, a PIN of the virtual gift card, or a combination thereof. In one embodiment, the transaction platform 109 may receive a validation request from a point-of-sale terminal to validate the point-of-sale transaction associated with the virtual gift card. In one scenario, the POS terminal operator may scan the barcode of at least one virtual gift card. This result in the POS terminal sending the information to the transaction platform 109 to control the virtual card and authorize the transaction. In one scenario, the transaction may include activation, redemption, reloading, sharing, and so on.

In step 503, the transaction platform 109 may initiate a validation of the virtual gift card by querying the wallet database to determine a validation response.

In step 505, the transaction platform 109 may transmit the validation response to the point-of-sale terminal. In one scenario, the POS terminal may send an information message to the transaction platform 109 to authorize a transaction. The transaction platform 109 sends back a response that can be either a positive response or a negative response. If the response is positive, the activation, redemption, reloading, sharing, sending, or a combination thereof of the virtual gift card may be in effect.

In step 507, the transaction platform 109 may update the wallet database based on the validation response, the point-of-sale transaction, or a combination thereof to refresh the application of the mobile device. In one scenario, if the transaction platform 109 approves the activation, or a reload or a redemption of a virtual gift card, the balance and status of the virtual gift card immediately changes. The wallet database is updated at the first refresh following the transaction.

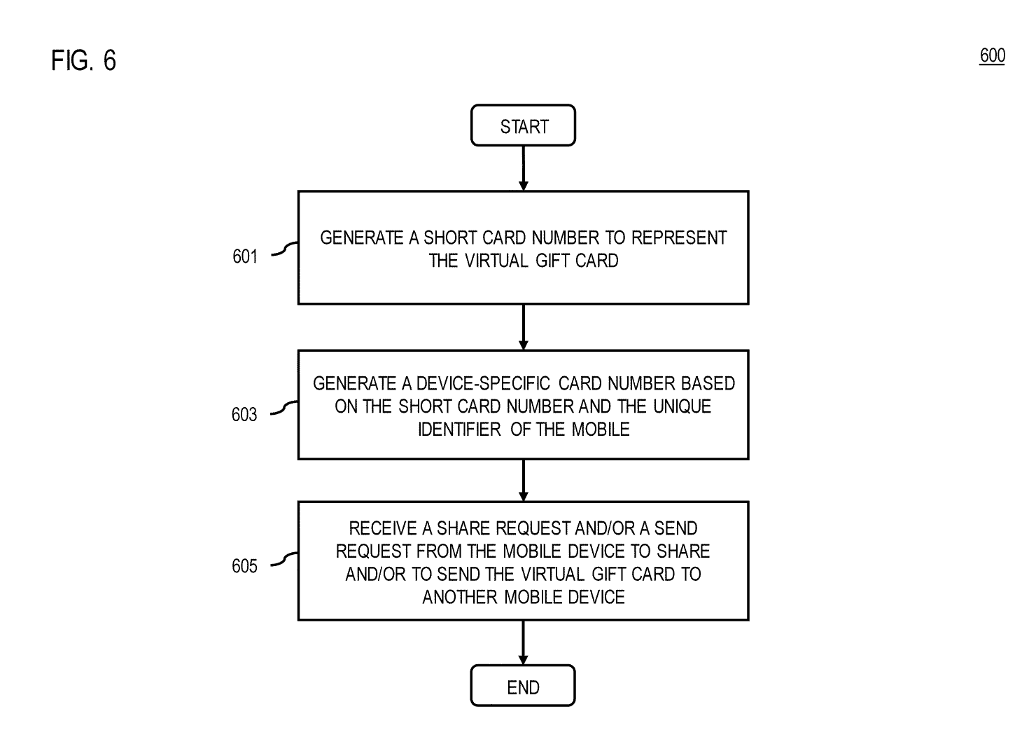

FIG. 6 is a flowchart of a process for sharing or sending a virtual gift card to another mobile device, according to one embodiment. In one embodiment, the transaction platform 109 performs the process 600 and is implemented in, for instance, a chip set including a processor and a memory as shown in FIG. 19.

In step 601, the transaction platform 109 may generate a short card number to represent the virtual gift card. In one scenario, at least one virtual gift card linked to the MSISDN number may have a new short card number with four security digits. The at least one virtual gift card may be linked with this short card number to several MSISDN number wallets.

In step 603, the transaction platform 109 may generate a device-specific card number based on the short card number and the unique identifier of the mobile. In one embodiment, the device-specific card number is used for conducting one or more transactions associated with the virtual gift card.

In step 605, the transaction platform 109 may receive a share request, a send request, or a combination thereof from the mobile device to share, to send, or a combination thereof the virtual gift card to another mobile device. In one embodiment, for a share request, the wallet database is updated to register the virtual gift card as active for the mobile device and the another mobile device. In another embodiment, for a send request, the wallet database is updated to register the virtual card as active for the another mobile device and as inactive for the mobile device. In a further embodiment, the share request, the send request, or a combination thereof is initiated via a social networking service, an email service, a messaging service, or a combination thereof. In another embodiment, the share request, the send request, or combination thereof include one or more criteria for the another mobile device to satisfy before registering the virtual gift card to the another mobile device. The one or more criteria include playing a game, completing a task, or a combination thereof associated with the application.

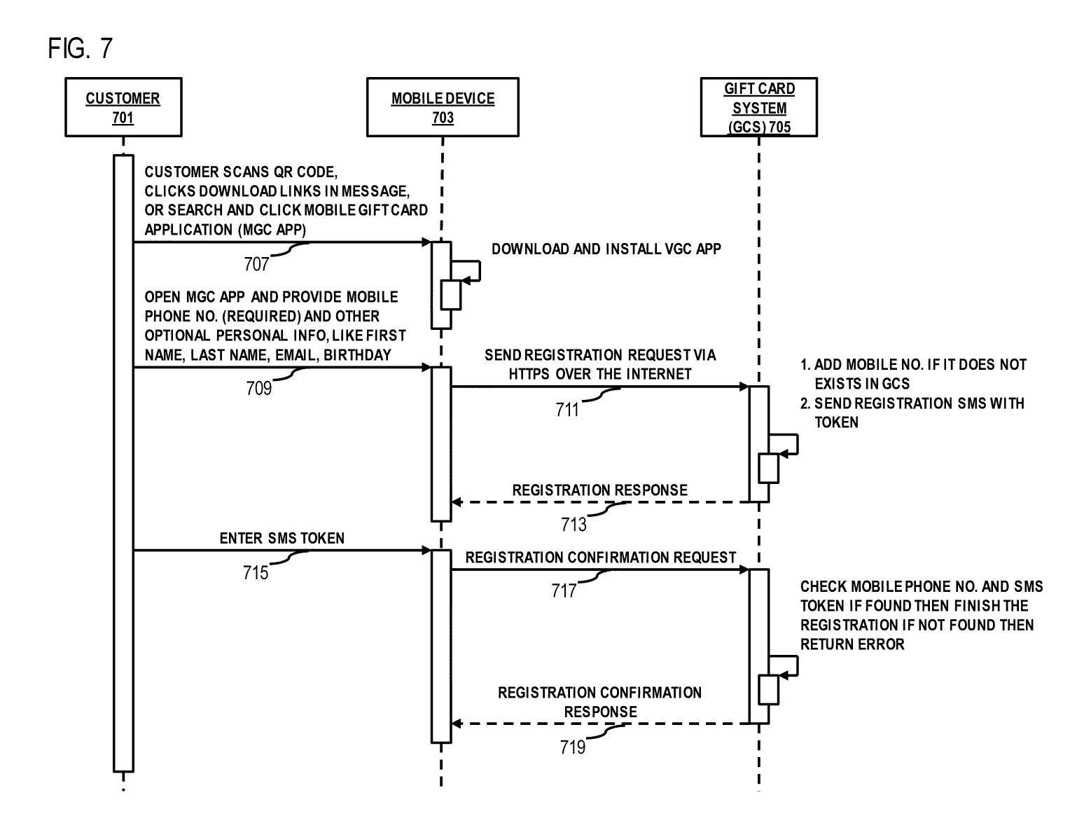

FIG. 7 is a ladder diagram utilized in the process of registering and creating a wallet linked to a MSISDN number of at least one mobile device, according to one embodiment. In step 707, the customer 701 of the mobile device 703 scans a quick response (QR) code and/or downloads a link associated with at least one message and/or search for a virtual gift card application (VGC App). Once the VGC App is downloaded the customer 701 may open the application and provide one or more contextual information associated with the mobile device 703 (step 709). In step 711, the mobile device 703 may send the contextual information, alongside the registration request, over the internet to the gift card system (GCS) 705, whereby the GCS 705 may add the contextual information, if not already existing, therein. Thereupon, the GCS 705 may send a registration response to the mobile device 703 in a message format with a token (step 713). Subsequently, the customer 701 may enter the received message token (step 715), which may trigger the mobile device 703 to send a registration confirmation request to the GCS 705 (step 717). Thereafter, the GCS 705 may verify the mobile phone number and the message token upon confirmation that the information is accurate, a registration confirmation may be sent (step 719). However, if the information provided does not conform, an error message may be sent to the mobile device 703.

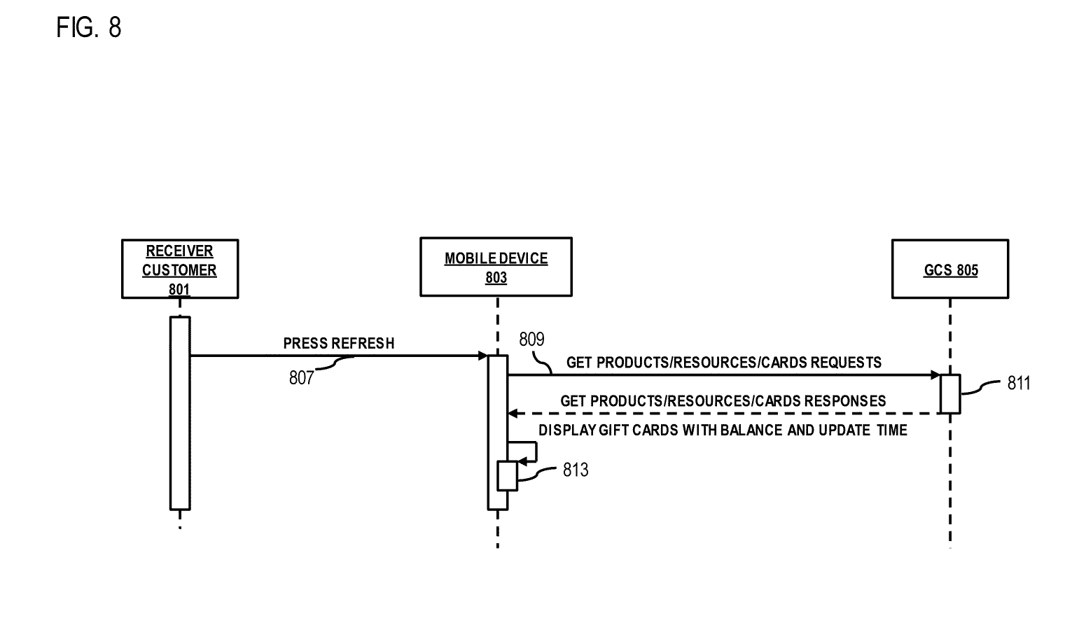

FIG. 8 is a ladder diagram utilized in the process of refreshing the mobile device application, according to one embodiment. In step 807, the receiving customer 801 may cause refreshing of the mobile device application by pressing the refresh tab displayed in the user interface of the mobile device 803, whereupon the mobile device 803 may send a request for the updated information on the one or more products, one or more resources, one or more cards to GCS 805 (step 809). Then, GCS 805 may process the request and verify the information of mobile device 803 (step 811) and upon confirmation send the requested information to the mobile device 803 (step 813), whereupon the mobile device application may be refreshed, or may simply display a new gift card icon on the mobile gift application.

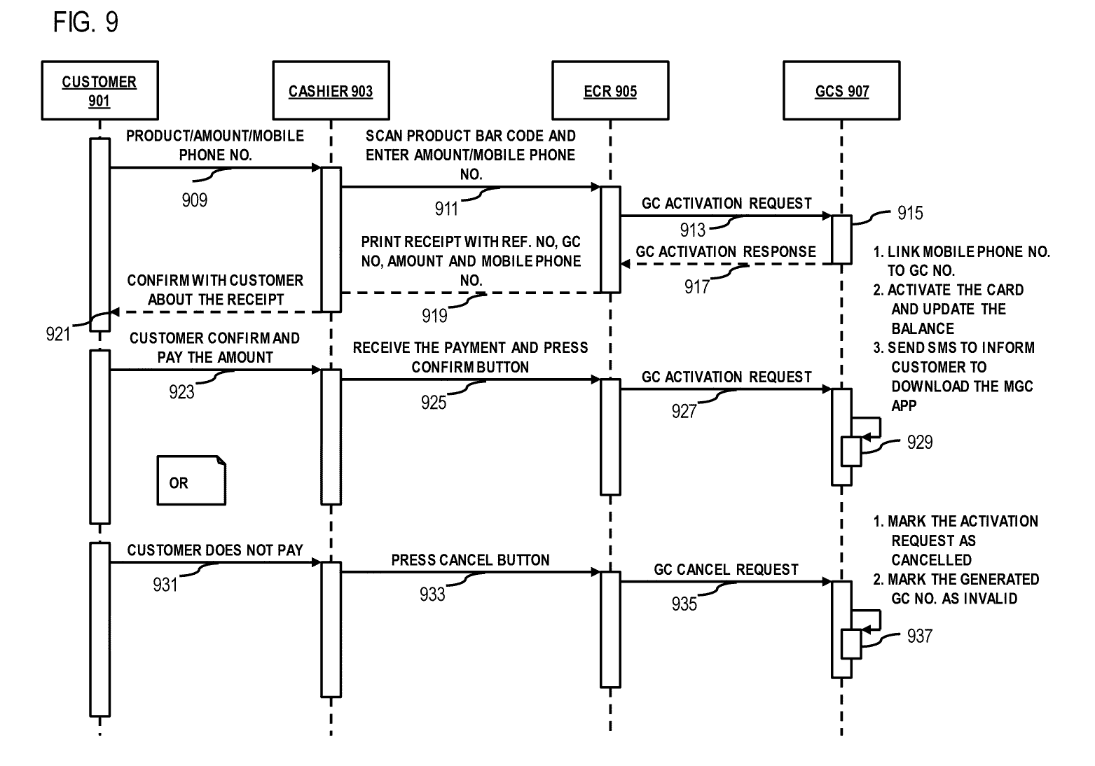

FIG. 9 is a ladder diagram utilized in the process of activating at least one virtual gift card, according to one embodiment. In one embodiment, the system is composed of a POS terminal, front servers and a database server. All the data of the system is centralized in one central database server, communicating with front servers, which communicate through gateways with the POS terminals. With a POS terminal application or an application programming interface (API) operated by the POS terminal operator, all the POS are integrated and connected to the front servers. In one embodiment, a web based back office interface software accessible via the communication network allows the entire monitoring of the gift card system which may include, but is not limited to, integration of the system into a company's organization and front office, definition and configuration of card types and properties, making card printing orders, generating card numbers, generating reports, managing customer service, etc. Further, the card number may be encrypted for communication purposes.

In one embodiment, the physical gift cards as well as the virtual gift cards must be activated at a POS terminal. The process of activating one or more virtual gift cards includes the following steps:

(i) First, the POS terminal operator selects on the POS terminal application the activation transaction. Alternatively, the card item EAN13 barcode is part of an item category which triggers the activation process.
(ii) Second, the POS terminal operator scans the bar code or swipes the magnetic stripe of the card, whereby the POS terminal sends an information message to the front server to control the card and authorize the activation transaction.
(iii) Third, the front server sends back a response that can be either positive or negative to the transaction authorization request, and a unique reference number is attributed by the system to the transaction.
(iv) Fourth, if the response is positive, the amount of money corresponding to the activation is collected by the POS terminal operator.
(v) Fifth, the POS operator hits the confirm button or cancel button in the POS terminal application and a confirmation or cancellation message is sent to server for this activation, respectively.

In one embodiment, once the activation is confirmed, the balance and status of the card immediately changes in the system. In addition, the corresponding wallet database associated with the MSISDN number is also updated at the first refresh following the transaction. Further, a receipt is automatically printed, with the reference number of the transaction, the card number and the new balance of the card. In one scenario, plastic cards and/or dummy cards can become virtual gift cards and loaded directly in the mobile device application. When the activation process is confirmed, a window pops up on the POS terminal screen to request the MSISDN from the consumer. By entering the corresponding MSISDN number in the POS terminal application during the activation, the POS terminal operator will associate the card number with the MSISDN in the server database. If the MSISDN number is unknown in the database, an SMS may be sent to the MSISDN to explain the process to load the mobile application. In addition, a link to each loading platform will be displayed.

In step 909, the customer 901 provides the cashier 903 with the gift card and the contextual information, for example, product information, mobile device information, amount information etc. Then, the cashier 903 may scan the bar code of the gift card and enter the amount of the gift card alongside the mobile phone number (step 911) and transmit the information to the electronic cash register (ECR) 905, which upon verification of the information, may send the request for gift card activation to GCS 907 (step 913). At this point, the GCS 907 may link the mobile phone number to the gift card number and/or activate the card, and update the information and/or send information to the customer 901 to download the VGC App (step 915). In step 917, the GCS 907 may send a gift card activation response to the cashier 903 via ECR 905 (step 917 and 919), whereupon the cashier 903 may print a receipt with other contextual information (step 919), and may confirm with the customer (step 921). In another scenario, the customer may confirm the and pay the amount of the gift card to cashier 903 (step 923), then the cashier 903 may acknowledge receipt of payment and press the confirm tab thereby transmitting the information to ECR 905 (step 925), whereupon ECR 905 may send a gift card activation request to GCS 907 (step 927) whereupon GCS 907 may link the mobile phone number to the gift card number and/or activate the card and update the information and/or send information to the customer 901 to download the VGC App (step 929). On the other hand, if the customer 901 does not pay (step 931) then cashier 903 may press the cancel transaction tab and the information with regards to the cancelled transaction may be transmitted to ECR 905 (step 933), thereupon the gift card cancel request may be sent to GCS 907 whereupon GCS 907 may mark the activation request for the gift card as cancelled and/or mark the generated gift card number as invalid (steps 935, 937).

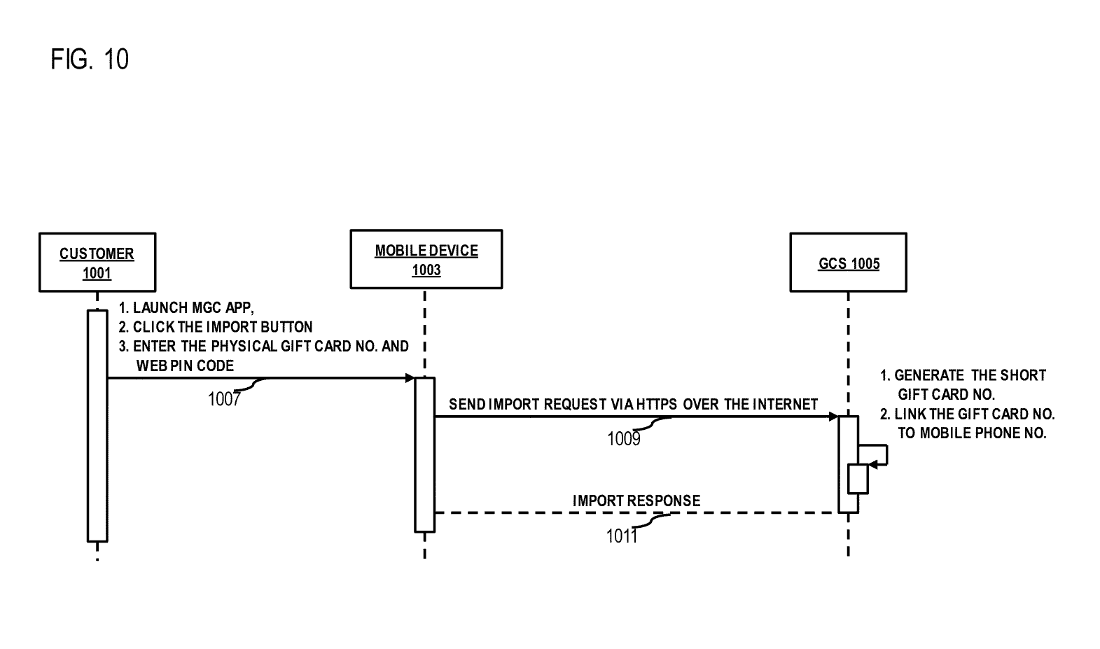

FIG. 10 is a ladder diagram utilized in the process of importing a physical gift card as a virtual gift card on a wallet associated with the MSISDN number of a mobile device, according to one embodiment. In one scenario, the plastic and/or paper cards can be directly imported after activation by their holder in a MSISDN wallet associated with the MSISDN number of a mobile device. To do this, the user must link the virtual gift card to the wallet associated with the MSISDN number of a mobile device by inputting the virtual gift card number and the web pin code in the mobile application. Subsequently, the virtual gift card is added to the wallet after the user prompts a page refresh. In one embodiment, when a card is linked to the wallet, a new short card number with four security digits may be created, resulting in a new corresponding bar code generated for this card and the wallet only. This means that one virtual gift card can be linked with this short card number to several other wallet associated with the MSISDN number of a mobile device. The purpose is of this short card number is to ensure security against fraud and to allow the system to identify, in the case of a shared card, which wallet is operating which transaction. The new short card number may change overtime and may be synchronized with the POS terminals. In step 1007, the customer 1001 may initiate importing a physical card as a mobile card on a MSISDN wallet by launching the mobile device gift card application and then clicking the import tab and providing the physical gift card number and the web pin code via mobile device 1003. Then, in step 1009, the mobile device 1003 sends an import request via https over the internet to the GCS 1005 (step 1009), whereby the GCS 1005 may generate a short gift card number and link the gift card number to the mobile phone number and provide the obtained information to mobile device 1003 (step 1011).

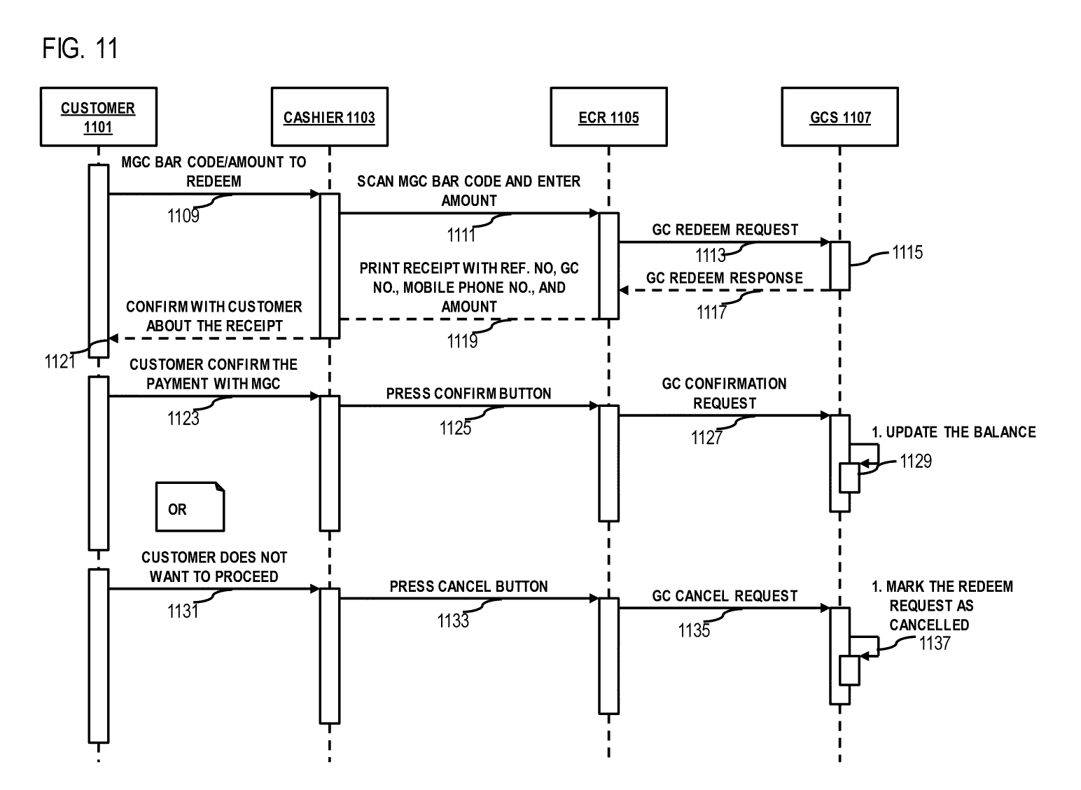

FIG. 11 is a ladder diagram utilized in the virtual gift card redemption process, according to one embodiment. In one scenario, if allowed by card configuration, a card holder may ask for the redemption of the amount on his/her card at any POS terminals integrated into the system for payment of purchased items. The process for operating card redemption includes the following steps:

(i) First, the POS terminal operator selects the redemption transaction on the POS terminal application. The POS operator inputs the amount of money to be redeemed for this transaction.
(ii) Second, the POS terminal operator scans the bar code or the magnetic stripe of the card. The POS terminal then sends an information message to the front server to control the card and authorize the redemption transaction.
(iii) Third, the front server responds either a positively or negatively to the transaction authorization request, and the system attributes a unique reference number by to the transaction. If the response is positive, the POS operator hits the confirm button or cancel button in the POS terminal application, and conversely, a confirmation or cancellation message is sent to server for this redemption in the case of a negative response.
(iv) Fourth, if the redemption is confirmed, the balance and status of the card immediately changes in the system. In addition, the wallet is also updated pursuant to the first refresh following the transaction. Subsequently, a receipt is automatically printed, with the reference number or the transaction, the card number, and the new balance of the card.

In step 1109, the customer 1101 may provide the cashier 1103 with the virtual gift card bar code and the amount that is to be redeemed. The cashier 1103 may scan the virtual gift card bar code and may enter the amount that is to be redeemed (step 1111) and transmit the information to the ECR 1105. Upon verification of the information, the ECR 1105 may send a request for redeeming the gift card (step 1113). Then, the GCS 1107 may provide with the authorization for redeeming the gift card (step 1115), and provide a response to the ECR 1105 (step 1117). At this point, the ECR 1105 may transmit the response to the cashier 1103, who may print a receipt of the response for redeeming the gift card, and the receipt may include a mobile phone number and the amount information etc. (step 1119). Then, the cashier 1103 may confirm with the customer 1101 that the instruction received conforms to the instructions provided by the customer 1101 (step 1121). In step 1123, the customer 1101 may confirm the payment regarding the virtual gift card with the cashier 1103, as a result of which the cashier 1103 may confirm the process for redeeming the gift card by pressing the confirm tab (step 1125). The confirmation may be transmitted to ECR 1105 and may be further transmitted to GCS 1107 upon verification of information (step 1127). Subsequently, GCS 1107 may update the balance information of the gift card (step 1129). On the other hand, if the customer 1101 decides not to proceed with the process for redeeming the gift card, the customer 1101 may inform the cashier 1103 (step 1131), and the cashier 1103 may press the cancel tab, thereby cancelling the request for redeeming the gift card (step 1133). The request for cancellation of the redemption process may be sent by the ECR 1105 to the GCS 1107 (step 1135), upon which the GCS 1107 may mark the request for redeeming the gift card as cancelled (step 1137).

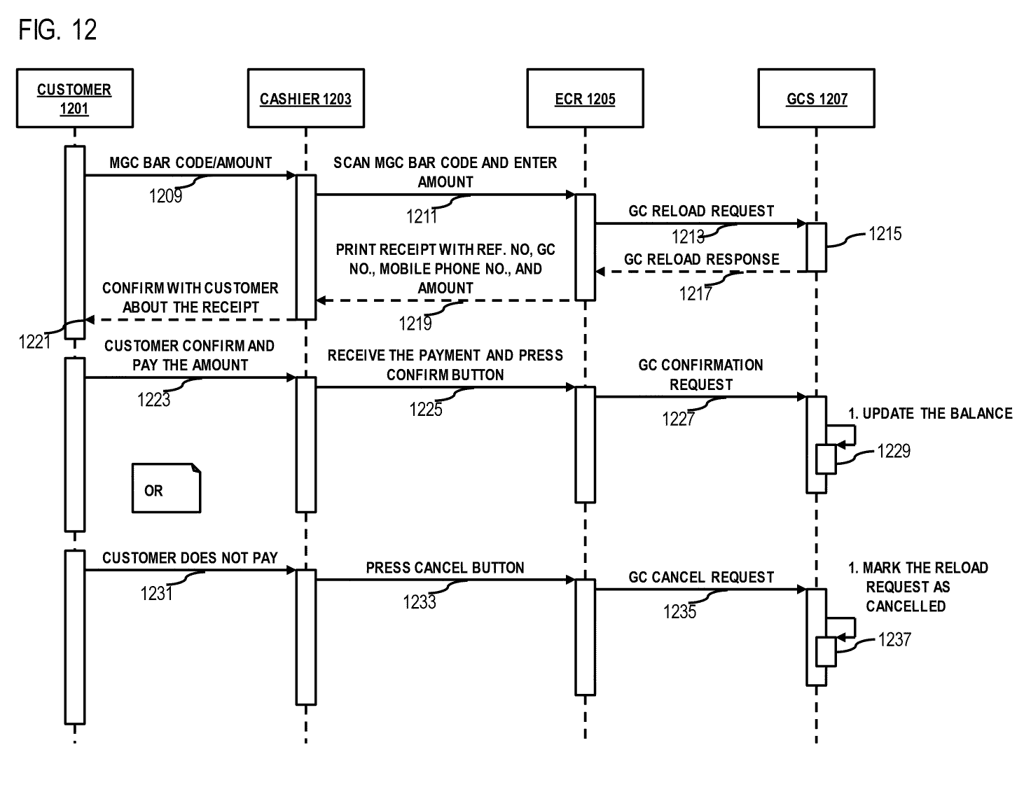

FIG. 12 is a ladder diagram utilized in the process of reloading one or more virtual gift cards, according to one embodiment. In one scenario, a card holder may reload his/her gift card at the POS terminal if allowed by the card configuration. The process of reloading a card include the following steps:

(i) First, the POS terminal operator selects the reload transaction on the POS terminal application
(ii) Second, the POS terminal operator scans the bar code of the mobile device or swipes the magnetic stripe of the card, and then sends an information message to the front server to control the card and authorize the reload transaction.
(iii) Third, the front server responds either positively or negatively to the transaction authorization request, and a unique reference number is attributed by the system to the transaction. If the response is positive, the amount of money corresponding to the reload is collected by POS terminal operator.
(iv) Fourth, the POS operator hits confirm or cancel button in the POS terminal application and respectively, a confirmation or cancellation message is sent to the server for this reload. If the reload is confirmed, the balance and status of the card immediately changes in the system. The MSISDN wallet is updated at the first refresh following the transaction. In addition, a receipt is automatically printed, with the reference number of the transaction, the card number, and the new balance of the card.

In step 1209, customer 1201 may provide cashier 1203 with a virtual gift card bar code and the information amount for reloading the gift card. The cashier 1203 may scan the bar code and enter the amount into the system (step 1211). The cashier 1203 may provide the information to the ECR 1205, whereupon the ECR 1205 may send a reload request to the GCS 1207 (step 1213). In step 1215, the GCS 1207 may process the request for reloading the gift card and may provide a confirmation upon verification of all the required information. In step 1217, GCS 1207 may provide ECR 1205 with the response regarding the reloading of the gift card. The ECR 1205 upon receiving a reload confirmation may print the receipt with the reference number, the gift cards reference number, mobile phone number, and the reload amount, whereupon the ECR 1205 sends the instructions to cashier 1203 (step 1219). Subsequently, the information may be provided to the customer 1201 for confirmation (step 1221). In step 1223, the customer 1201 may confirm the receipt information and make the payment for the requested reload of the gift card. Then, the cashier 1203, upon receiving the payment, may confirm the payment by pressing the confirm tab, whereby the payment confirmation information may be transmitted to the ECR 1205 (step 1225). Subsequently, the gift card reload confirmation request may be sent by the ECR 1205 to the GCS 1207. In step 1229, the GCS 1207 may update the balance for the gift card by reloading the gift card with the amount paid by the customer 1201. On the other hand, if the customer 1201 does not pay (step 1231), the cashier 1203 may cancel the transaction for reload by pressing the cancel tab (step 1233). Then, the information may be relayed to the ECR 1205 and the GCS 1207 (steps 1233 and 1235) whereby the GCS 1207 may update its record by marking the request for reloading the gift card as cancelled (step 1237).

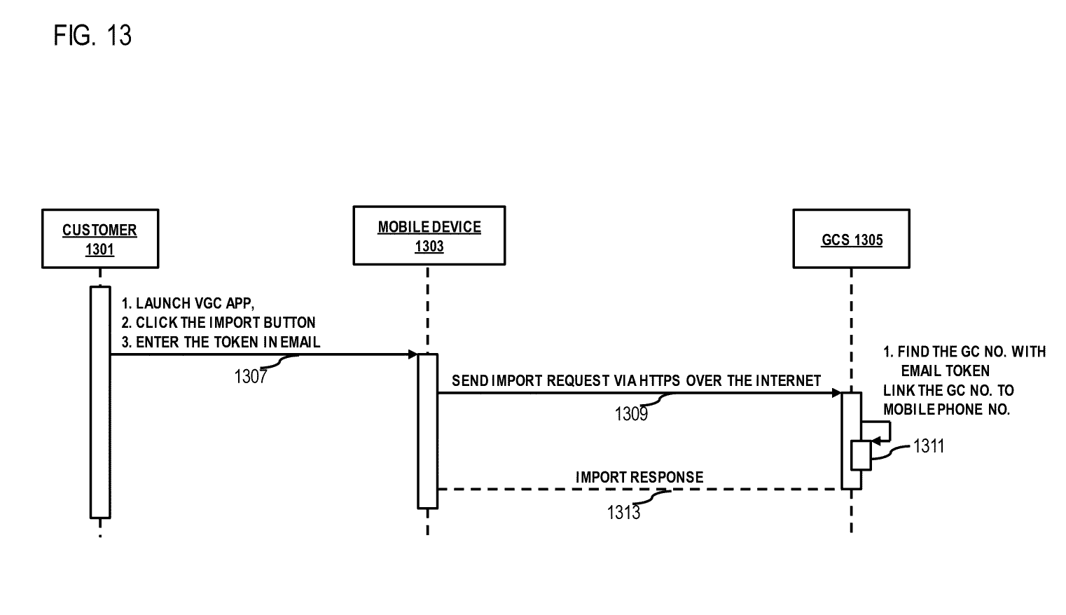

FIG. 13 is a ladder diagram utilized in the process of importing a sent email or a shared gift card to the receiver's MSISDN wallet, according to one embodiment. In step 1307, customer 1301 may launch the VGC application in his mobile device 1303, and then customer 1301 may click the import tab and enter the token information. Successively, the mobile device 1303 may send import requests via the communication network to the gift card system (GCS) 1305 (step 1309). This initiates importing of sent email or shared gift cards to the receiver's MSISDN wallet. In step 1311, the GCS 1305 finds the gift card number with the email token and links the gift card number to the unique identifier of the mobile device (e.g., MSISDN number) for importing sent email or a shared gift cards. Then, the GCS 1305 may send the import response to mobile device 1303 (step 1313).

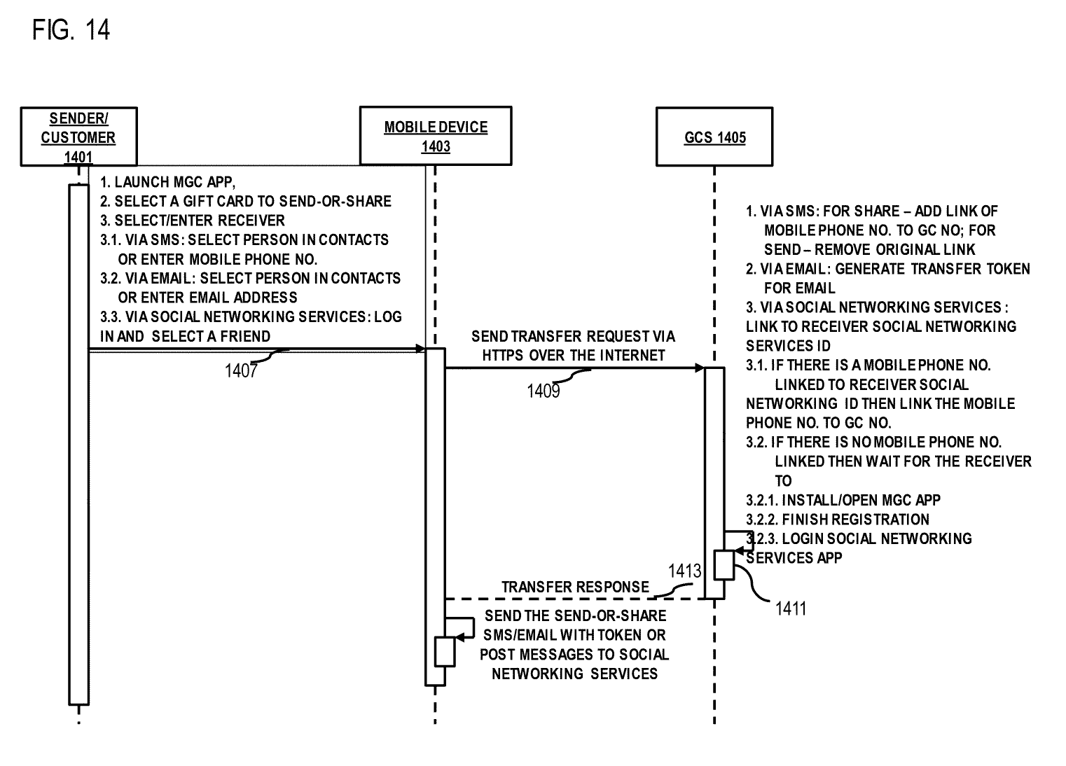

FIG. 14 is a ladder diagram utilized in the process of sending or sharing a virtual gift card, according to one embodiment. In one embodiment, virtual gift card holders may send or share (depending on the card configuration) their virtual gift cards to other users of one or more mobile device 1403. In one scenario, if the virtual gift card is shared, the card remains in the sender's wallet in the mobile application and can be used by all holders. However, if the virtual gift card is sent, redeem and reload function for the virtual gift card is deactivated from the sender's wallet, and can only be used by the receiver. Additionally, the sent function may become a resend function whereby the sender is allowed to resend the card to the same or other beneficiary. In this case, the last MSISDN in the database will be allowed to redeem the card.

In step 1407, the sender/customer 1401 may launch the VGC App in the mobile device 1403. Then, the sender/customer 1401 may select a virtual gift card to send or share. Subsequently, the sender/customer 1401 may select and/or enter the receiver of the gift card. In one scenario, the sender/customer 1401 may select the receiver via SMS by, for example, selecting a person from their contacts or entering the receiver's mobile phone number. In one scenario, the sender/customer 1401 may select the recipients via email, whereby the sender/customer 1401 may enter their contacts or respective email addresses. In one scenario, the sender/customer 1401 may also utilize social networking services and/or contextual information determination services to select one or more recipients. In step 1409, the mobile device 1403 may transmit the information provided by the sender/customer 1401 alongside a transfer request via the internet to the gift card system (GCS) 1405. In step 1411, the GCS 1405 may initiate the process for sending or sharing the virtual gift card via SMS and/or email and/or social networking services. In one scenario, the GCS 1405 may share the gift card via SMS by adding a link of the mobile phone number to the gift card number. In one scenario, the GCS 1405 may share the gift card via email by generating a transfer token for email. In one scenario, the GCS 1405 may share the gift card via social networking services, wherein the mobile phone number may be linked with the social networking ID before linking the mobile phone number to the gift card number (step 1413). However, if there is no mobile phone number, then the sender/customer 1401 may wait for the receiver/customer to install and open the VGC application, finish the registration process, and then log into the social networking services application. Next, the GCS 1405 may transfer the response to the mobile device 1403, followed by the mobile device 1403 sending or sharing an SMS or email with the token embedded therein, or posting messages to the social networking services for sending or sharing of the virtual gift cards. In one scenario, this process may be undertaken to select at least one friend from the list of friends in the at least one social networking services. It is not necessary for the users to select the at least one friend through their mobile device 101, neither is there a need for the one or more senders to enter the receiver's mobile numbers. The list of friends for at least one social networking service may be displayed in the user interface of the mobile device 101 by their respective social networking application. Then, the social networking application may cause a presentation guiding the user to add the recipient from the list. In one scenario, the at least one user of the mobile device 101 may use the social networking services API, thereby creating an intent interface between the VGC App and the social networking application.

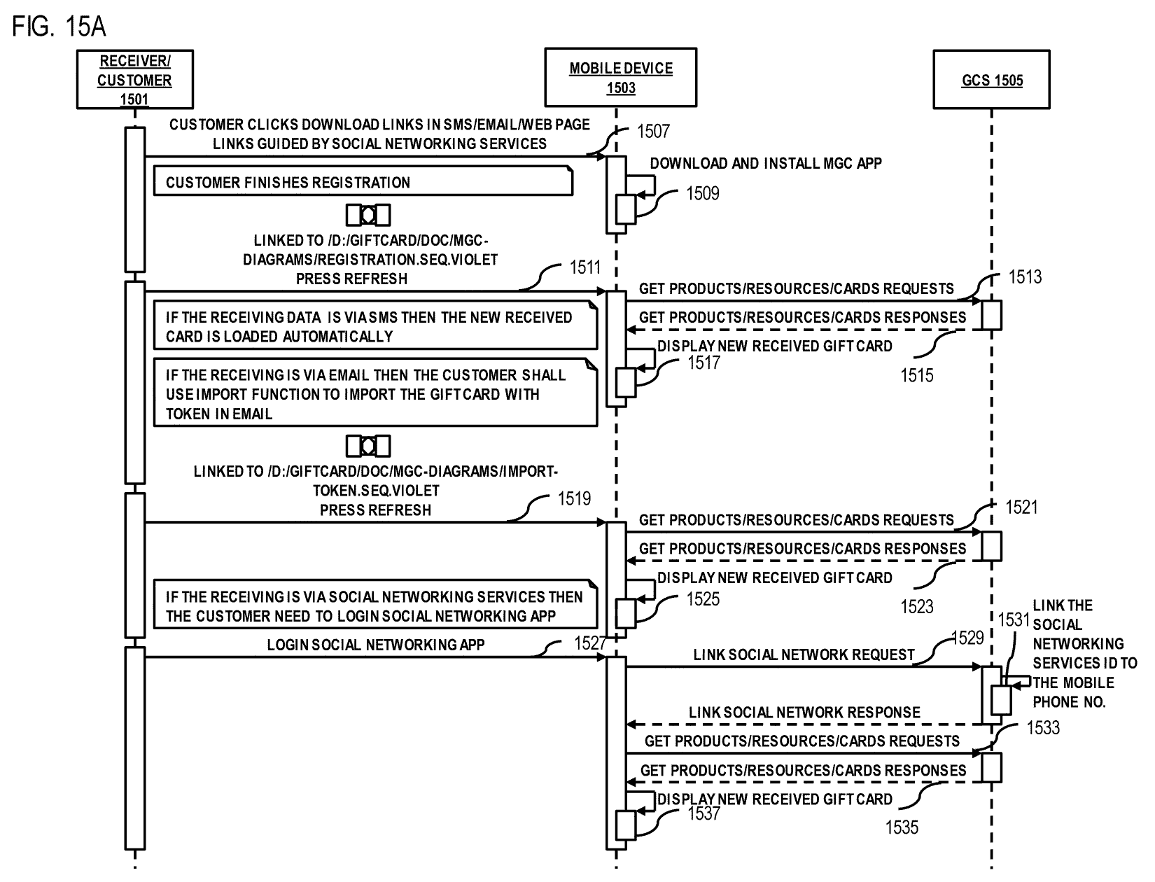

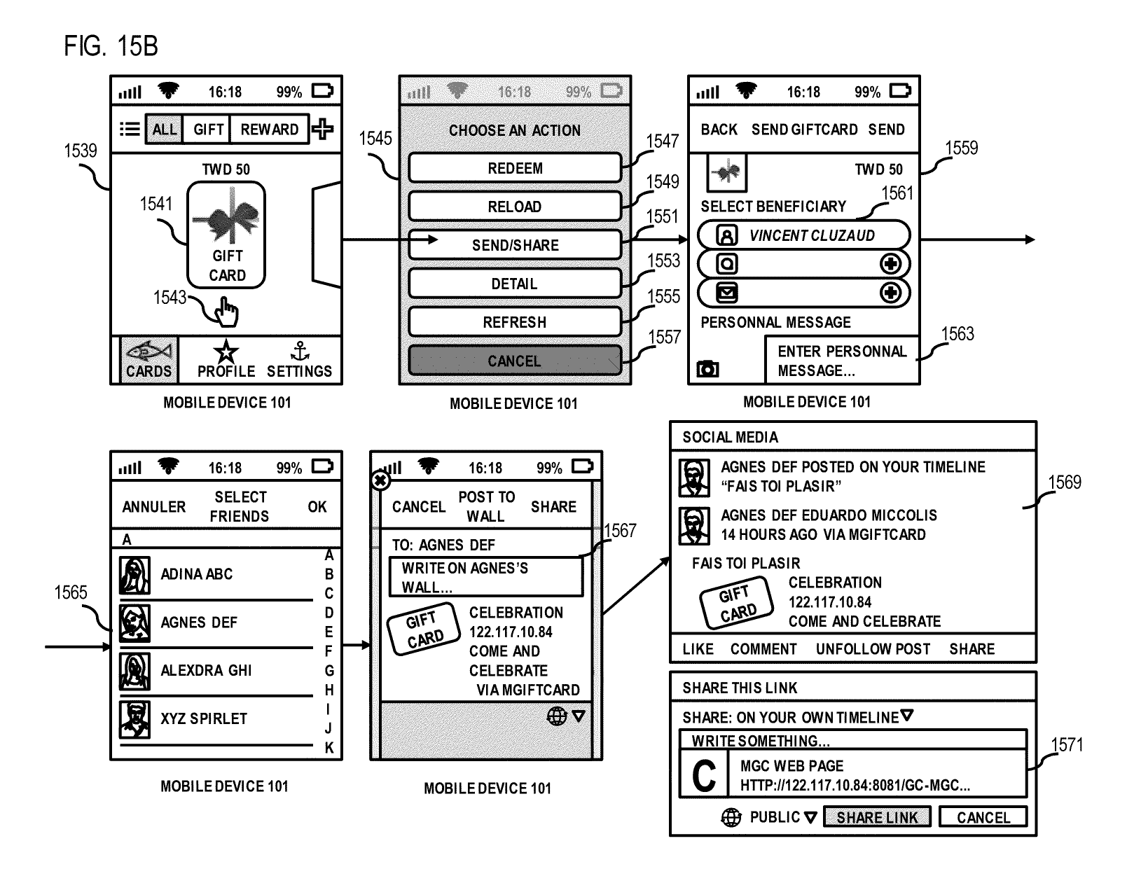

FIG. 15A is a ladder diagram utilized in the process of importing a sent or shared virtual gift card to the receiver's wallet database associated with the MSISDN number of the at least one mobile device, according to one embodiment. In one embodiment, the virtual gift cards may be sent or shared through an internet social network. The mobile application may be linked to the API of the social network via a gateway, or communicate with the social network's application resident in the mobile device 1503 via intents. In one scenario, the holder of a virtual gift card may log his social network credentials into the mobile application settings, wherein the holder may select a receiver in his/her contacts list in the social network. Subsequently, the receiver may be informed by a post on his/her social media account. In one scenario, the MSISDN number of the holder may be associated with his/her social media account. Consequently, a notification may appear in the mobile application. As soon as the receiver opens his/her mobile application, the virtual gift card may pop up in the application cover flow. In one embodiment, when a card is sent or shared through an internet social network, the operation is published into the public news feed of the target receiver, this publication may include an invite by the host, thereby giving an opportunity to the contacts to know more about the system, to download the mobile application, and also possibly benefit from promotional offers that they can accept by entering their MSISDN number. This feature adds a viral marketing side to the social network sending or sharing of a virtual gift card. In one scenario, when the user receives a sent and/or shared virtual gift card in his MSISDN wallet on the mobile application, the receiver is given the opportunity to enjoy his/her gift by playing a game embedded in the application before accessing the new card. In one scenario, a virtual gift card may be sent or shared via e-mail. Further, the receiver may receive a token to add the card to his/her wallet database associated with the MSISDN number of the mobile device 1503. In one scenario, one or more virtual gift cards can be sent or shared via SMS, wherein the receiver receives an SMS notification of the virtual gift card, while the virtual gift card is automatically added to its wallet database of the MSISDN number of the mobile device 1503. Further, when a card holder sends or shares a card, he may write a message, take or upload a photo, record or upload a video. These contents may be attached to the virtual gift card (e.g. using the photo, video and messaging features of the mobile device 1503) for the recipient to receive it in his/her wallet database. In one scenario, the system operates a reconciliation process at the end of every accounting day. This daily reconciliation consists of comparing past day's transaction records of the database, and the POS terminals in order to identify the potential anomalies that may have occurred.

In step 1507 the receiver/customer 1501 may download gift cards links in SMS and/or email and/or web page links guided by the at least one social networking services. In step 1509, the receiver/customer 1501 may download the virtual gift card (VGC) application in the mobile device 1503 and complete the registration process.

In one scenario, the VGC application may be linked with the gift card (step 1511). The mobile device 1503 may request for product information and/or resources and/or gift card information from the GCS 1505 (step 1513), whereupon the GCS 1505 may verify the information, and may deliver the information accordingly (step 1515). In step 1517, the mobile device 1503 may automatically load the gift card if the data is received via SMS. However, if the data is received via email, then the import function may be used to import the gift card with token in the email.

In one scenario, the mobile device 1503 may request for product information and/or resources and/or gift card information from the GCS 1505 (step 1519), whereupon the GCS 1505 may verify the information, and may deliver the information accordingly (step 1523). If the information is received via social networking services then the customer needs to login to the social networking application (steps 1525 and 1527). Then, the mobile device 1503 may link the social networking requests to the GCS 1505 (step 1529) whereby the GCS 1505 may link the social networking services identification to the mobile phone number (step 1531). Subsequently, the GCS 1505 may send a response to the mobile device 1503 pertaining to social network request link. In step 1533, the mobile device 1503 may request product information and/or resources and/or card requests from the GCS 1505 after linking the social network. In one scenario, the link may be automated for at least one social networking service wherein user login may not be required. The social networking services API and/or an intent interface between the VGC App and the social networking services application may emulate the at least one social networking service displaying the list of friends and/or a message input. In one scenario, the receiver's social networking profile may be sent to the GCS 1505, wherein the virtual gift card is automatically presented via social networking services API and/or an intent interface between the VGC App and the social networking services application. Then, upon verification of the information, the GCS 1505 may provide the mobile device 1503 with the requested information (step 1535). Further, the information may be displayed on the user interface of the mobile device 1503 (step 1537).

FIG. 15B is a user interface diagram utilized in the process of linking a social media service application to a VGC App, according to one embodiment. In one scenario, the user interface of the at least one mobile device 101 (step 1539) may cause a presentation of a gift card (step 1541) whereby the at least one user is guided to click on the gift card icon (step 1543) to select the gift card in the list or the cover flow. Once the user clicks on the gift card icon (step 1541), the user may be prompted with the option of choosing one of the many action items, for instance, redeeming the gift cards (step 1547), or reloading the gift cards (step 1549), or sending/sharing the gift cards (step 1551), or details of the gift cards (step 1553), or refreshing the gift cards (step 1555), or cancelling the gift cards (step 1557). In one scenario, the user may choose to send the gift card to at least one recipient whereby the user may choose an option to check into a social networking service (step 1559). Subsequently, the user may choose a recipient from the list of contacts in the social networking service (step 1561). There is no need for the user to enter the receiver's phone number as the list of contacts displayed by the social networking service application is descriptive. In addition, the user may leave a personal message to the recipient of the virtual gift card (step 1563). In one scenario, the social network service API or an intent interface between the VGC App and the social networking services application may assist the user in selecting a recipient from the list. The user may select a recipient (step 1565). Consequently, the user may be prompted to enter a message for the recipient (step 1567). The entered message may be posted on the social networking service profile of the recipient (step 1569). In one scenario, there may be an option of switching to a gift card URL where any social network friend of the recipient can input their MSISDN and receive a gift card or may add money to the gift card (step 1571).

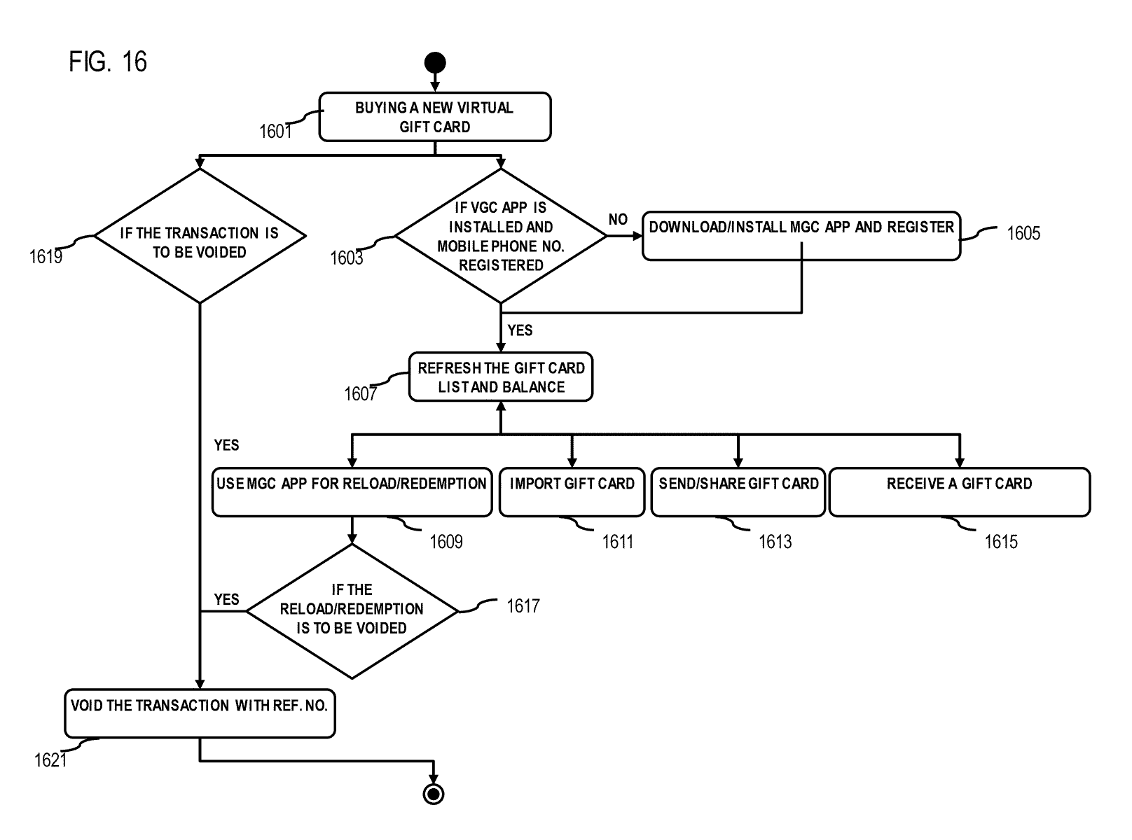

FIG. 16 is a flowchart of a process utilized in the functioning of the virtual gift cards in a wallet database, according to one example embodiment. In one scenario, one or more customers may purchase a new virtual gift card (step 1601). The customer may proceed with the activation of the virtual gift card, if the VGC application is already installed in the mobile device 101 and the mobile phone number is registered (step 1603). If the VGC application is not installed, the customer needs to download and install the VGC application (step 1605). In one scenario, if the wallet database already contains information on one or more one other virtual gift cards, the gift cards list and the balance information may be updated with the addition of the new gift card information (step 1607). In one scenario, the VGC application may be utilized for reloading and/or redemption of the one or more gift cards (step 1609). In one scenario, the one or more physical and/or virtual gift cards may be imported as per requirement (step 1611). In one scenario, the one or more virtual gift cards may be sent or shared with other customer as per requirement (step 1613). In one scenario, a receiving customer may receive a virtual gift card from a sending customer and may active the card in the manner aforementioned (step 1615). In the last phase of the process, the customer is given an option to cancel the entire transaction (step 1617), if the customer so wishes, he/she may cancel the transaction (step 1621). In another scenario, if the customer wishes to cancel the transaction after purchasing the new virtual gift card (step 1619), the customer may cancel the transaction by providing required gift card information (step 1621).

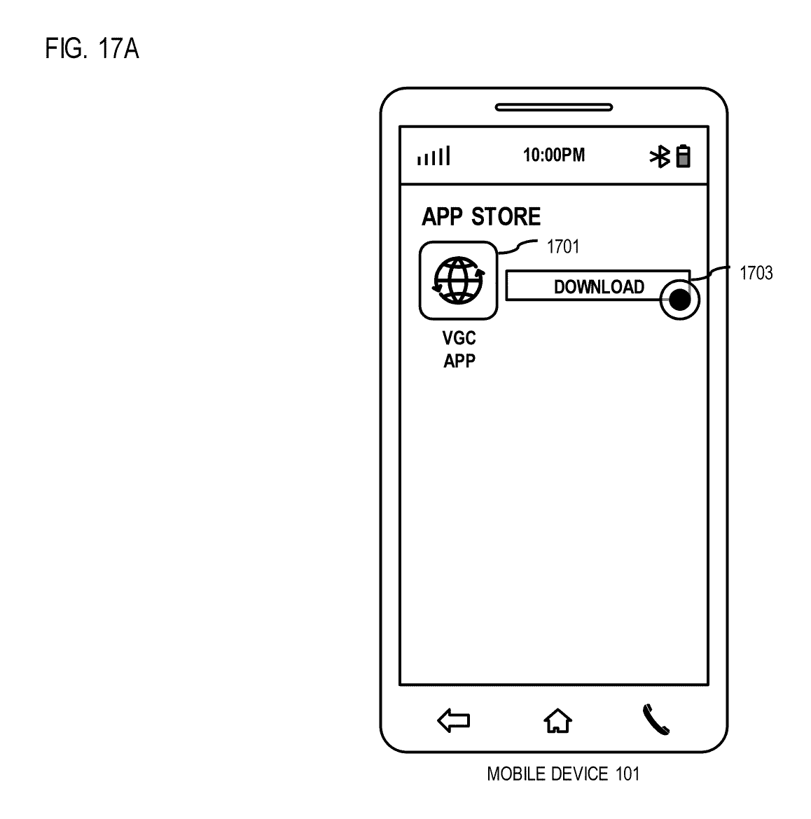

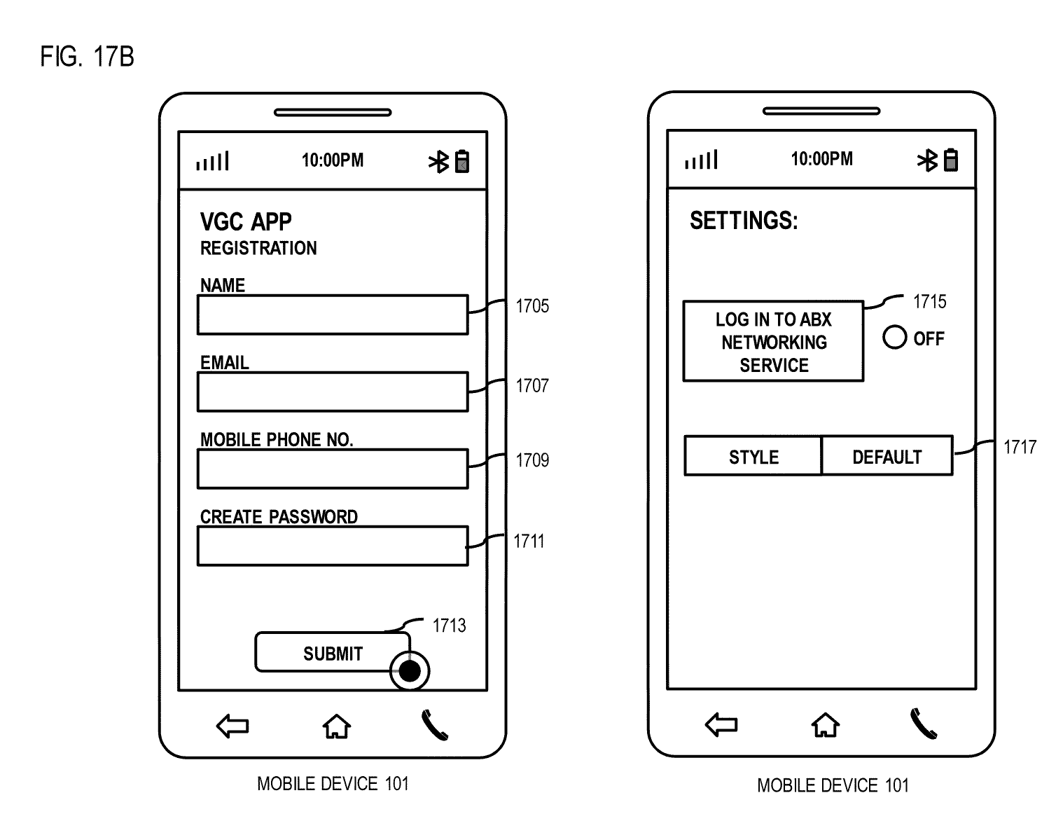

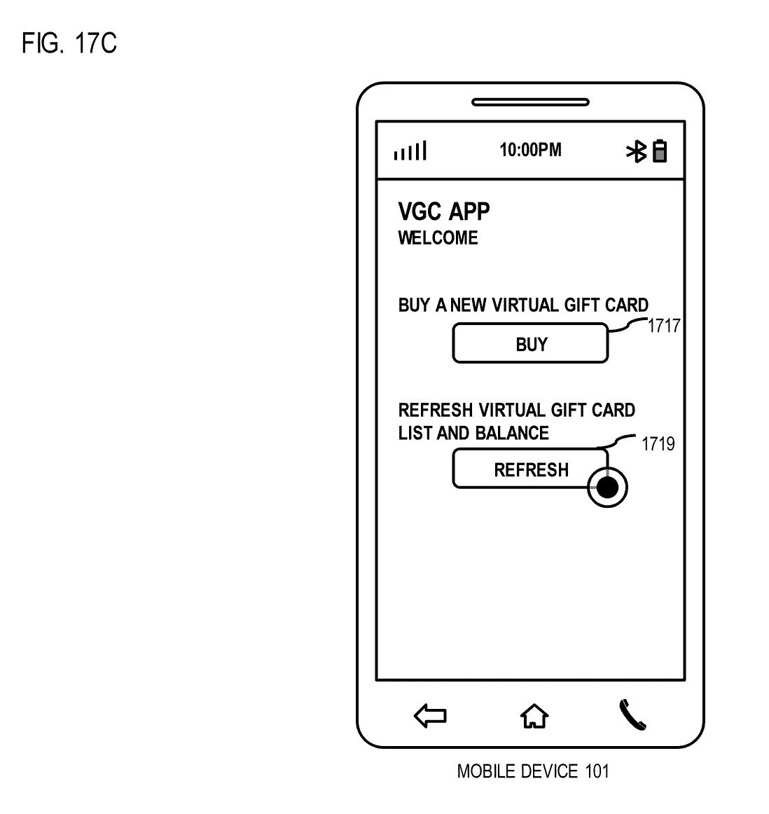

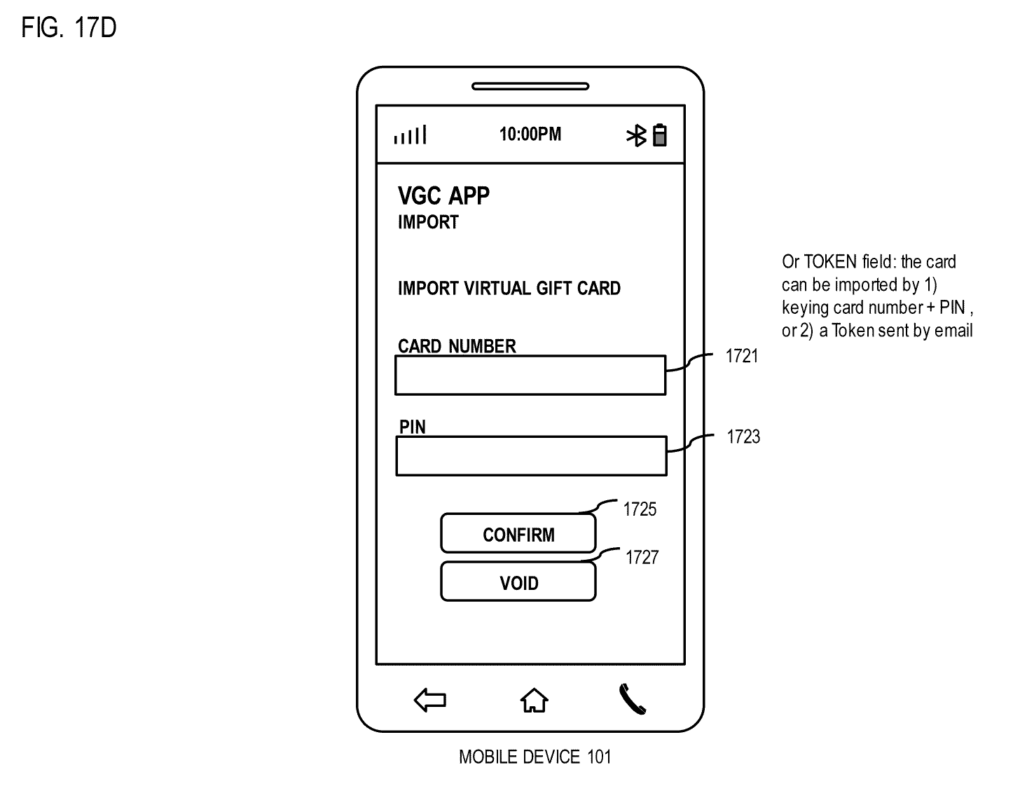

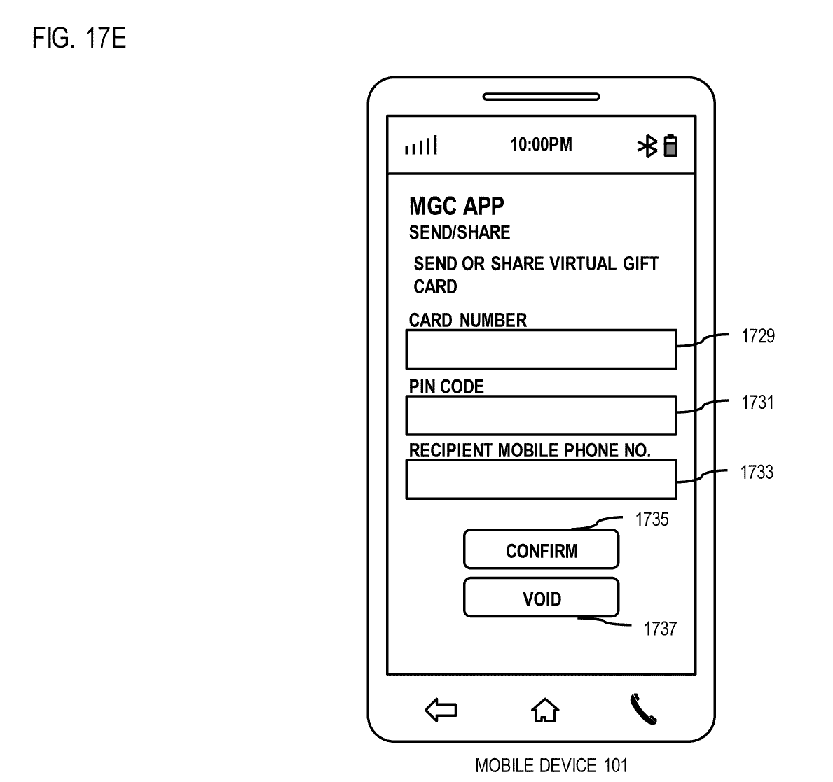

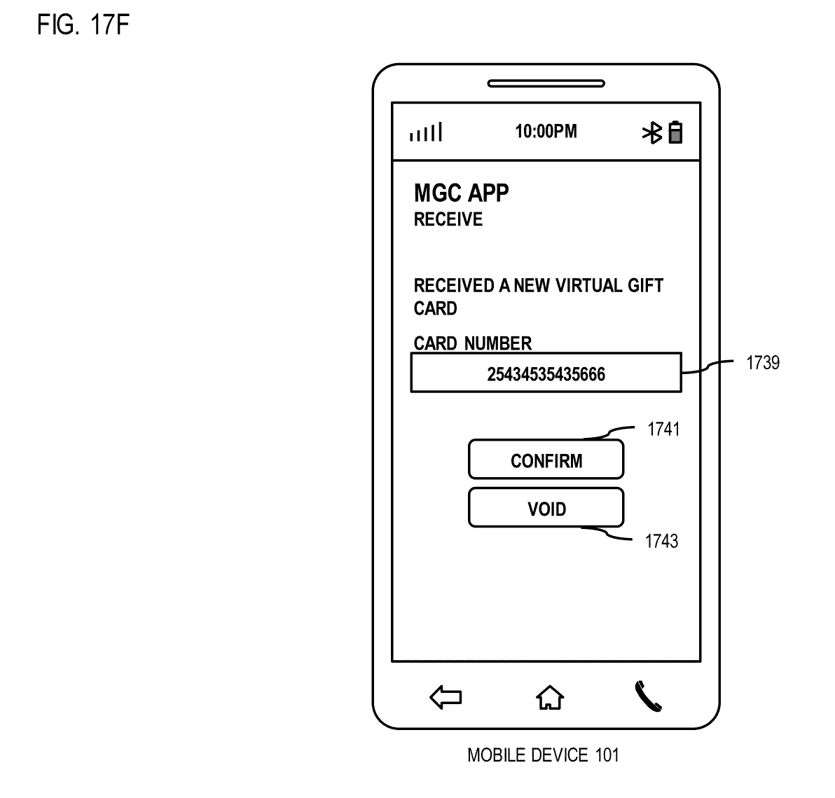

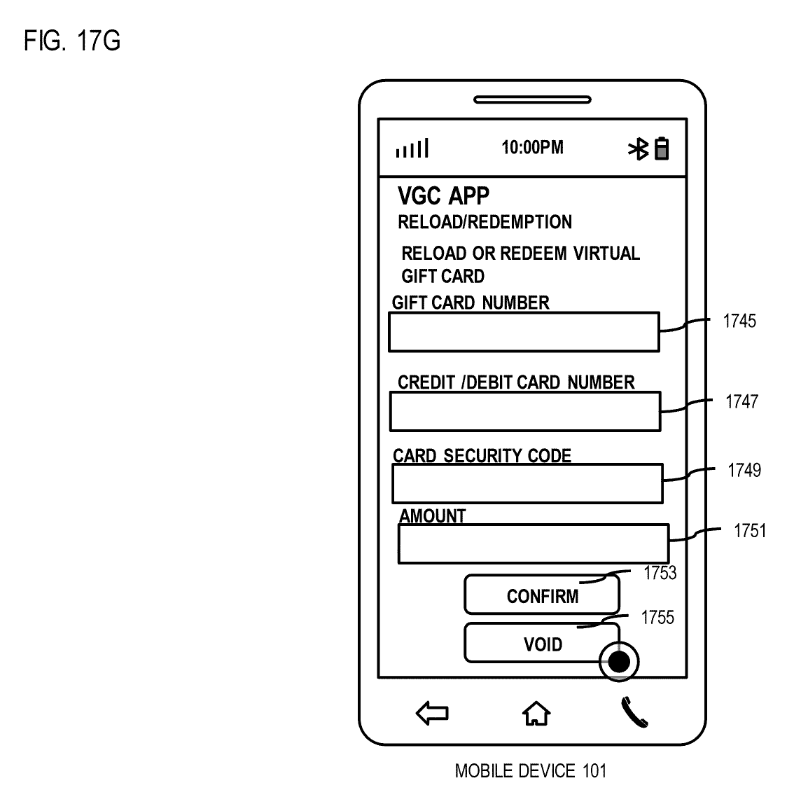

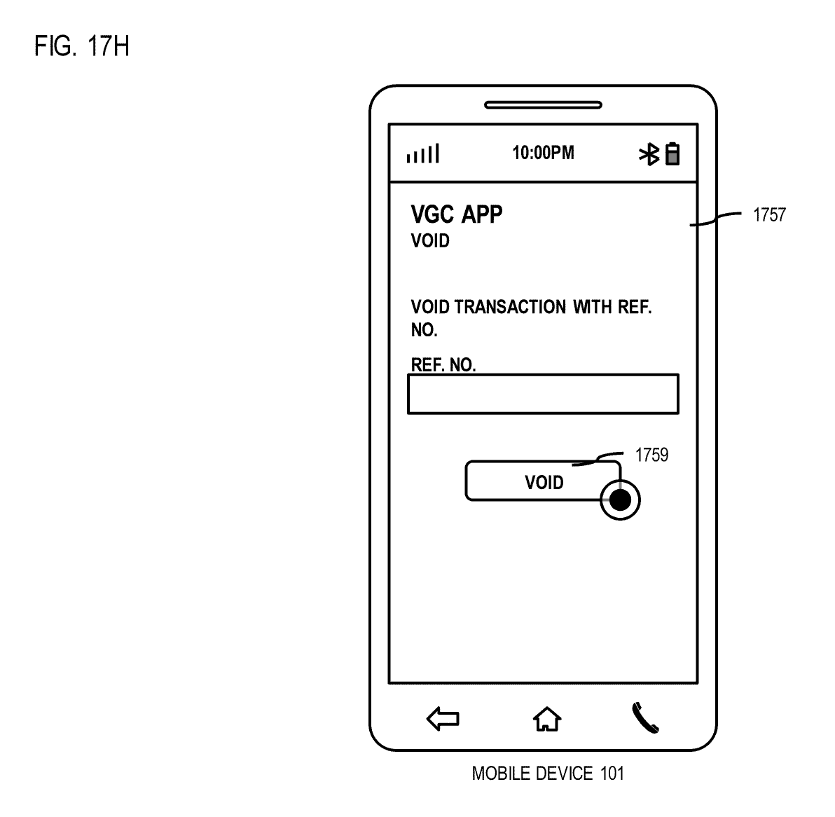

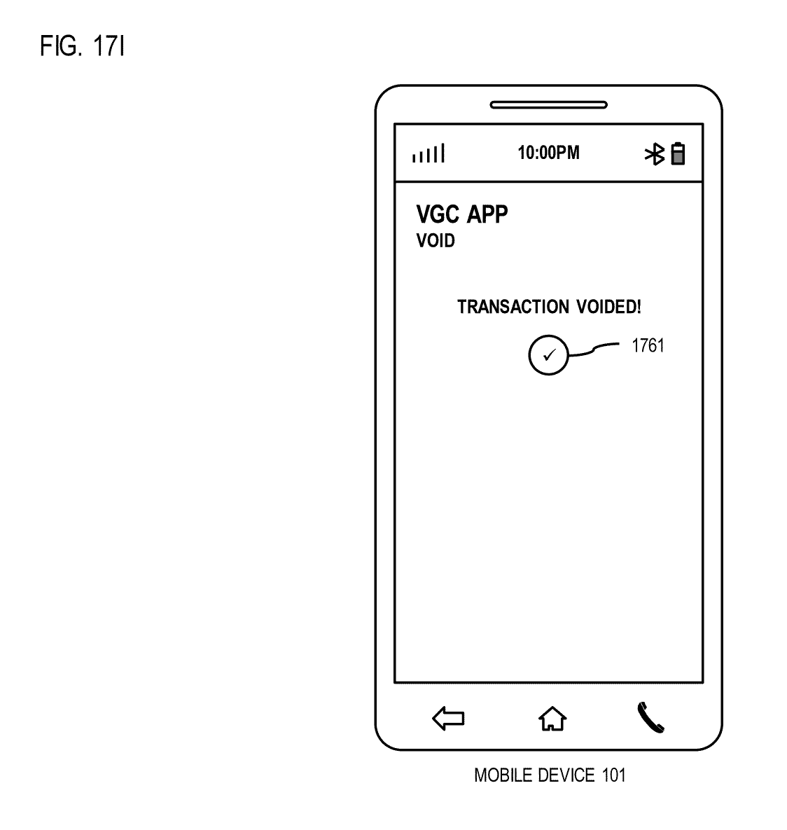

FIGS. 17A-17I are diagrams of user interfaces utilized in the processes of FIGS. 3-6, according to various embodiments. FIG. 17A represents a scenario wherein at least one user downloads an application (e.g. VGC App) in his/her mobile device 101 to use the one or more virtual gift cards [1701, 1703]. FIG. 17B represents a scenario wherein an application (e.g. VGC App) is successfully installed in the mobile device 101, and the user initiates the registration process for linking one or more virtual gift cards to the wallet database associated with the unique identifier of at least one mobile device. In one scenario, the registration process may involve the mobile application prompting the user to enter his/her name (step 1705), email-id (step 1707), mobile phone number (step 1709), create password of choice (step 1711) and others. The user may provide the information to the service provider by clicking submit (step 1713). In one scenario, the registration process may involve adding one or more social network links by default (steps 1715, 1717), for example, the installed mobile application (e.g. VGC App) may be linked to the ABX networking services (step 1715). FIG. 17C represents a scenario in which the installed mobile application may prompt a user to buy a new virtual gift card (step 1717). In one scenario, the mobile application may prompt the user to refresh the list for gift cards and their balance upon determination that the user has previously used virtual gift cards (step 1719). In another scenario, virtual gift cards may be refreshed upon confirmation of the redemption request and/or reload request for at least one virtual gift card. FIG. 17D represents a scenario of importing one or more plastic and/or paper gift cards after activation by their holder in the wallet database of a mobile device 101. In one scenario, the mobile application may link the physical gift card to the wallet database based, at least in part, on card number, token information, web pin code of the card and so on. In one example embodiment, the user of a mobile device 101 may import a plastic and/or a paper gift card by entering the card number (step 1721) and the pin number (step 1723), or the user may enter a token received via email. Then, the user may submit the entered information by clicking confirm (step 1725) to import the plastic and/or paper gift cards. In another scenario, the user has the option of voiding the transaction by clicking void (step 1727). FIG. 17E represents the process of sending or sharing the virtual gift cards with other users of mobile device 101. In one scenario, the mobile application is linked to the API of the social network via a gateway, whereby the user may enter the receiver's social network credentials (steps 1729, 1731). Further, the user may either select a recipient from his contacts list or enter the mobile device number of the recipient (step 1733). Subsequently, the sender may either confirm sending or sharing of the gift card by clicking confirm (step 1735) or may cancel the transaction by clicking void (step 1737). In one scenario, the recipient may be notified via a post on his social media account. FIG. 17F represents a scenario wherein the user of a mobile device 101 receives a virtual gift card from the holder of the virtual gift card. In one scenario, when a user receives a sent or shared virtual gift card in his/her MSISDN wallet on the mobile application (step 1739), the user has the option to either accept the gift card (step 1741) or reject the gift card by clicking void (step 1743). FIG. 17G represents a scenario for reloading or redeeming virtual gift cards. In one scenario, the user may enter the gift card number (step 1745) and the amount (step 1751) that is to be redeemed from the virtual gift card. In another scenario, a user may reload at least one gift card whereby the user may enter the gift card number (step 1745), credit/debit card number (step 1747), the card security code (step 1749) and the reload amount (step 1751). Subsequently, the user has the option to either validate the transaction by clicking confirm (step 1753), or cancelling the entire transaction for reloading or redeeming a gift card by pressing void (step 1755). FIG. 17H represents the process of cancelling a transaction. In one scenario, the user may simply enter the reference number (step 1757) of the transaction he/she wishes to cancel. In another scenario, the user may enter the gift card number and the pin code of the gift card to cancel the transaction. Subsequently, the user may click void after providing the required information for cancelling the transaction (step 1759). FIG. 17I is a user interface representation of a confirmation presented to the at least one user of a mobile device 101 that the transaction has been annulled (step 1761).

The processes described herein for linking one or more virtual gift cards to the wallet database associated with the unique identifier of at least one mobile device may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

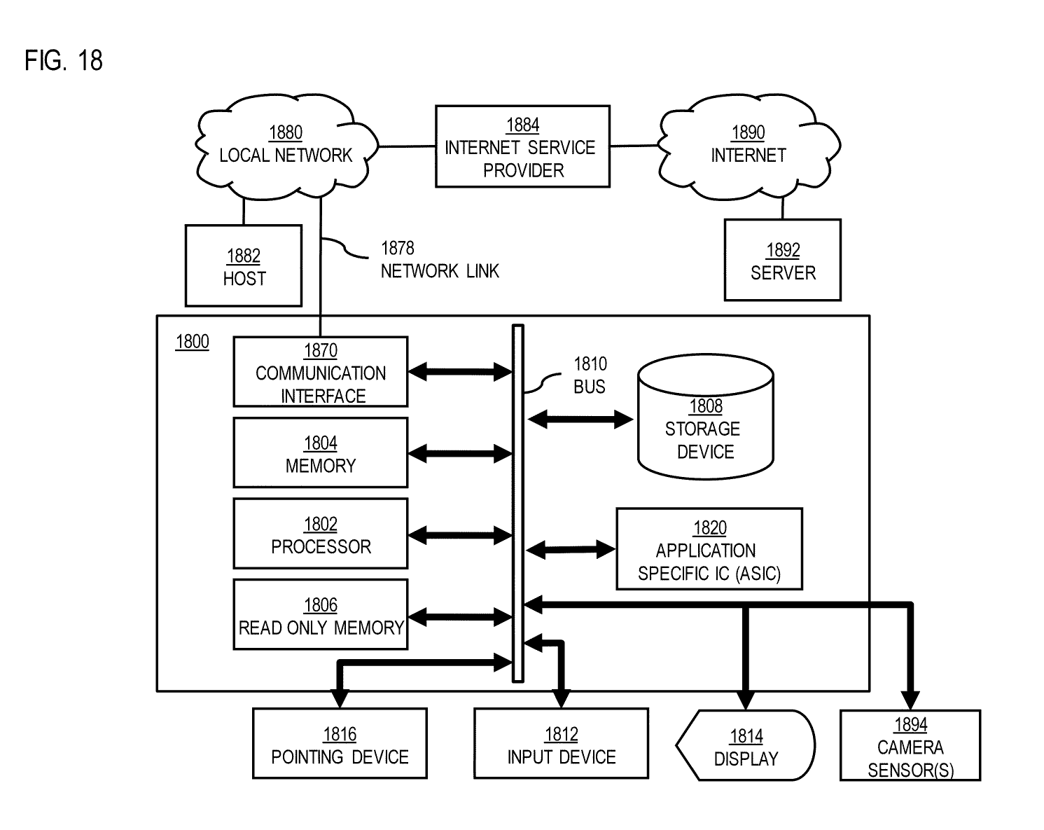

FIG. 18 illustrates a computer system 1800 upon which an embodiment of the invention may be implemented. Although computer system 1800 is depicted with respect to a particular device or equipment, it is contemplated that other devices or equipment (e.g., network elements, servers, etc.) within FIG. 18 can deploy the illustrated hardware and components of system 1800. Computer system 1800 is programmed (e.g., via computer program code or instructions) to link one or more virtual gift cards to the wallet database associated with the unique identifier of at least one mobile device as described herein and includes a communication mechanism such as a bus 1810 for passing information between other internal and external components of the computer system 1800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1800, or a portion thereof, constitutes a means for performing one or more steps of linking one or more virtual gift cards to the wallet database associated with the unique identifier of at least one mobile device.

A bus 1810 includes one or more parallel conductors of information so that information is transferred quickly among devices coupled to the bus 1810. One or more processors 1802 for processing information are coupled with the bus 1810.

A processor (or multiple processors) 1802 performs a set of operations on information as specified by computer program code related to link one or more virtual gift cards to the wallet database associated with the unique identifier of at least one mobile device. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1810 and placing information on the bus 1810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1802, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1800 also includes a memory 1804 coupled to bus 1810. The memory 1804, such as a random access memory (RAM) or any other dynamic storage device, stores information including processor instructions for linking one or more virtual gift cards to the wallet database associated with the unique identifier of at least one mobile device. Dynamic memory allows information stored therein to be changed by the computer system 1800. RAM allows a unit of information stored at a location called a memory address to be stored and retrieved independently of information at neighboring addresses. The memory 1804 is also used by the processor 1802 to store temporary values during execution of processor instructions. The computer system 1800 also includes a read only memory (ROM) 1806 or any other static storage device coupled to the bus 1810 for storing static information, including instructions, that is not changed by the computer system 1800. Some memory is composed of volatile storage that loses the information stored thereon when power is lost. Also coupled to bus 1810 is a non-volatile (persistent) storage device 1808, such as a magnetic disk, optical disk or flash card, for storing information, including instructions, that persists even when the computer system 1800 is turned off or otherwise loses power.

Information, including instructions for linking one or more virtual gift cards to the wallet database associated with the unique identifier of at least one mobile device, is provided to the bus 1810 for use by the processor from an external input device 1812, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1800. Other external devices coupled to bus 1810, used primarily for interacting with humans, include a display device 1814, such as a cathode ray tube (CRT), a liquid crystal display (LCD), a light emitting diode (LED) display, an organic LED (OLED) display, a plasma screen, or a printer for presenting text or images, and a pointing device 1816, such as a mouse, a trackball, cursor direction keys, or a motion sensor, for controlling a position of a small cursor image presented on the display 1814 and issuing commands associated with graphical elements presented on the display 1814, and one or more camera sensors 1894 for capturing, recording and causing to store one or more still and/or moving images (e.g., videos, movies, etc.) which also may comprise audio recordings. In some embodiments, for example, in embodiments in which the computer system 1800 performs all functions automatically without human input, one or more of external input device 1812, display device 1814 and pointing device 1816 may be omitted.

In the illustrated embodiment, special purpose hardware, such as an application specific integrated circuit (ASIC) 1820, is coupled to bus 1810. The special purpose hardware is configured to perform operations not performed by processor 1802 quickly enough for special purposes. Examples of ASICs include graphics accelerator cards for generating images for display 1814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1800 also includes one or more instances of a communications interface 1870 coupled to bus 1810. Communication interface 1870 provides a one-way or two-way communication coupling to a variety of external devices that operate with their own processors, such as printers, scanners and external disks. In general the coupling is with a network link 1878 that is connected to a local network 1880 to which a variety of external devices with their own processors are connected. For example, communication interface 1870 may be a parallel port or a serial port or a universal serial bus (USB) port on a personal computer. In some embodiments, communications interface 1870 is an integrated services digital network (ISDN) card or a digital subscriber line (DSL) card or a telephone modem that provides an information communication connection to a corresponding type of telephone line. In some embodiments, a communication interface 1870 is a cable modem that converts signals on bus 1810 into signals for a communication connection over a coaxial cable or into optical signals for a communication connection over a fiber optic cable. As another example, communications interface 1870 may be a local area network (LAN) card to provide a data communication connection to a compatible LAN, such as Ethernet. Wireless links may also be implemented. For wireless links, the communications interface 1870 sends or receives or both sends and receives electrical, acoustic or electromagnetic signals, including infrared and optical signals, that carry information streams, such as digital data. For example, in wireless handheld devices, such as mobile telephones like cell phones, the communications interface 1870 includes a radio band electromagnetic transmitter and receiver called a radio transceiver. In certain embodiments, the communications interface 1870 enables connection to the communication network 107 for linking one or more virtual gift cards to the wallet database associated with the unique identifier of at least one mobile device 101.

The term “computer-readable medium” as used herein refers to any medium that participates in providing information to processor 1802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1808. Volatile media include, for example, dynamic memory 1804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1820.

Network link 1878 typically provides information communication using transmission media through one or more networks to other devices that use or process the information. For example, network link 1878 may provide a connection through local network 1880 to a host computer 1882 or to equipment 1884 operated by an Internet Service Provider (ISP). ISP equipment 1884 in turn provides data communication services through the public, world-wide packet-switching communication network of networks now commonly referred to as the Internet 1890.

A computer called a server host 1892 connected to the Internet hosts a process that provides a service in response to information received over the Internet. For example, server host 1892 hosts a process that provides information representing video data for presentation at display 1814. It is contemplated that the components of system 1800 can be deployed in various configurations within other computer systems, e.g., host 1882 and server 1892.

At least some embodiments of the invention are related to the use of computer system 1800 for implementing some or all of the techniques described herein. According to one embodiment of the invention, those techniques are performed by computer system 1800 in response to processor 1802 executing one or more sequences of one or more processor instructions contained in memory 1804. Such instructions, also called computer instructions, software and program code, may be read into memory 1804 from another computer-readable medium such as storage device 1808 or network link 1878. Execution of the sequences of instructions contained in memory 1804 causes processor 1802 to perform one or more of the method steps described herein. In alternative embodiments, hardware, such as ASIC 1820, may be used in place of or in combination with software to implement the invention. Thus, embodiments of the invention are not limited to any specific combination of hardware and software, unless otherwise explicitly stated herein.

The signals transmitted over network link 1878 and other networks through communications interface 1870, carry information to and from computer system 1800. Computer system 1800 can send and receive information, including program code, through the networks 1880, 1890 among others, through network link 1878 and communications interface 1870. In an example using the Internet 1890, a server host 1892 transmits program code for a particular application, requested by a message sent from computer 1800, through Internet 1890, ISP equipment 1884, local network 1880 and communications interface 1870. The received code may be executed by processor 1802 as it is received, or may be stored in memory 1804 or in storage device 1808 or any other non-volatile storage for later execution, or both. In this manner, computer system 1800 may obtain application program code in the form of signals on a carrier wave.

Various forms of computer readable media may be involved in carrying one or more sequence of instructions or data or both to processor 1802 for execution. For example, instructions and data may initially be carried on a magnetic disk of a remote computer such as host 1882. The remote computer loads the instructions and data into its dynamic memory and sends the instructions and data over a telephone line using a modem. A modem local to the computer system 1800 receives the instructions and data on a telephone line and uses an infra-red transmitter to convert the instructions and data to a signal on an infra-red carrier wave serving as the network link 1878. An infrared detector serving as communications interface 1870 receives the instructions and data carried in the infrared signal and places information representing the instructions and data onto bus 1810. Bus 1810 carries the information to memory 1804 from which processor 1802 retrieves and executes the instructions using some of the data sent with the instructions. The instructions and data received in memory 1804 may optionally be stored on storage device 1808, either before or after execution by the processor 1802.

FIG. 19 illustrates a chip set or chip 1900 upon which an embodiment of the invention may be implemented. Chip set 1900 is programmed to link one or more virtual gift cards to the wallet database associated with the unique identifier of at least one mobile device as described herein and include, for instance, the processor and memory components described with respect to FIG. 18 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1900 can be implemented in a single chip. It is further contemplated that in certain embodiments the chip set or chip 1900 can be implemented as a single “system on a chip.” It is further contemplated that in certain embodiments a separate ASIC would not be used, for example, and that all relevant functions as disclosed herein would be performed by a processor or processors. Chip set or chip 1900, or a portion thereof, constitutes a means for performing one or more steps of providing user interface navigation information associated with the availability of functions. Chip set or chip 1900, or a portion thereof, constitutes a means for performing one or more steps of linking one or more virtual gift cards to the wallet database associated with the unique identifier of at least one mobile device.

In one embodiment, the chip set or chip 1900 includes a communication mechanism such as a bus 1901 for passing information among the components of the chip set 1900. A processor 1903 has connectivity to the bus 1901 to execute instructions and process information stored in, for example, a memory 1905. The processor 1903 may include one or more processing cores with each core configured to perform independently. A multi-core processor enables multiprocessing within a single physical package. Examples of a multi-core processor include two, four, eight, or greater numbers of processing cores. Alternatively or in addition, the processor 1903 may include one or more microprocessors configured in tandem via the bus 1901 to enable independent execution of instructions, pipelining, and multithreading. The processor 1903 may also be accompanied with one or more specialized components to perform certain processing functions and tasks such as one or more digital signal processors (DSP) 1907, or one or more application-specific integrated circuits (ASIC) 1909. A DSP 1907 typically is configured to process real-world signals (e.g., sound) in real time independently of the processor 1903. Similarly, an ASIC 1909 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1900 includes merely one or more processors and some software and/or firmware supporting and/or relating to and/or for the one or more processors.

The processor 1903 and accompanying components have connectivity to the memory 1905 via the bus 1901. The memory 1905 includes both dynamic memory (e.g., RAM, magnetic disk, writable optical disk, etc.) and static memory (e.g., ROM, CD-ROM, etc.) for storing executable instructions that when executed perform the inventive steps described herein to link one or more virtual gift cards to the wallet database associated with the unique identifier of at least one mobile device. The memory 1905 also stores the data associated with or generated by the execution of the inventive steps.

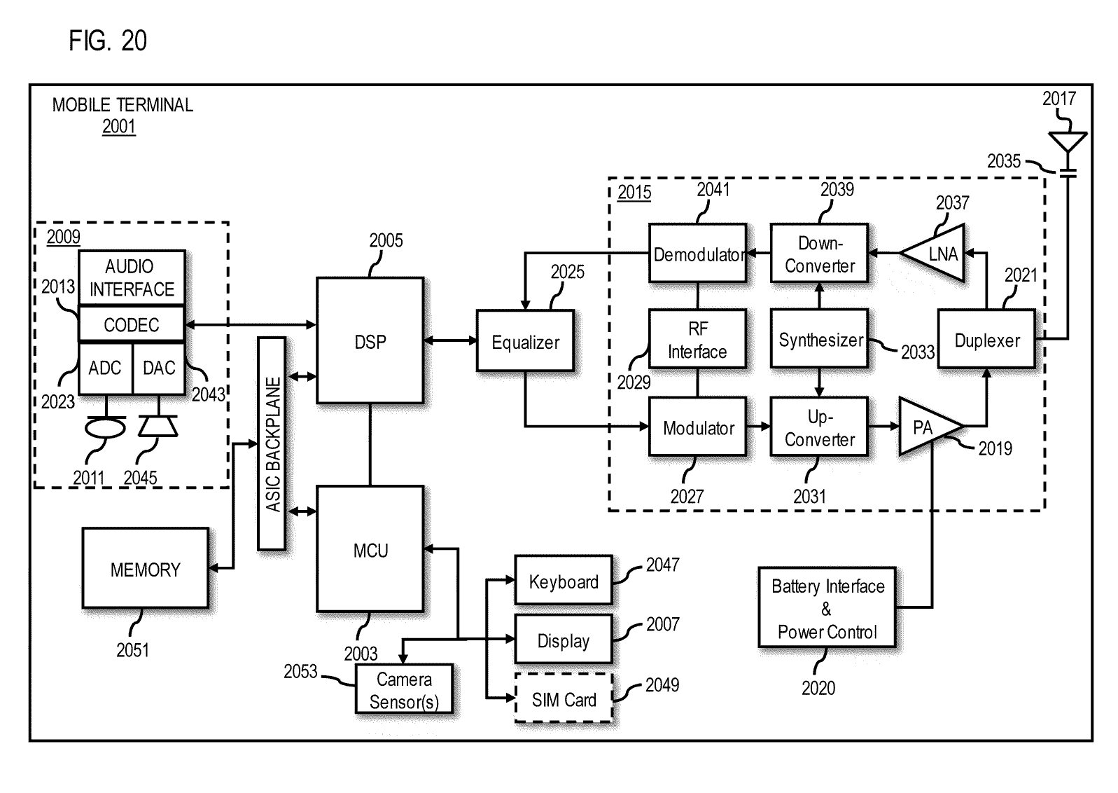

FIG. 20 is a diagram of exemplary components of a mobile terminal (e.g., handset) for communications, which is capable of operating in the system of FIG. 1, according to one embodiment. In some embodiments, mobile terminal 2001, or a portion thereof, constitutes a means for performing one or more steps of linking one or more virtual gift cards to the wallet database associated with the unique identifier of at least one mobile device. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 2003, a Digital Signal Processor (DSP) 2005, and a receiver/transmitter unit including a microphone gain control unit and a speaker gain control unit. A main display unit 2007 provides a display to the user in support of various applications and mobile terminal functions that perform or support the steps of linking one or more virtual gift cards to the wallet database associated with the unique identifier of at least one mobile device. The display 2007 includes display circuitry configured to display at least a portion of a user interface of the mobile terminal (e.g., mobile telephone). Additionally, the display 2007 and display circuitry are configured to facilitate user control of at least some functions of the mobile terminal. An audio function circuitry 2009 includes a microphone 2011 and microphone amplifier that amplifies the speech signal output from the microphone 2011. The amplified speech signal output from the microphone 2011 is fed to a coder/decoder (CODEC) 2013.

A radio section 2015 amplifies power and converts frequency in order to communicate with a base station, which is included in a mobile communication system, via antenna 2017. The power amplifier (PA) 2019 and the transmitter/modulation circuitry are operationally responsive to the MCU 2003, with an output from the PA 2019 coupled to the duplexer 2021 or circulator or antenna switch, as known in the art. The PA 2019 also couples to a battery interface and power control unit 2020.

In use, a user of mobile terminal 2001 speaks into the microphone 2011 and his or her voice along with any detected background noise is converted into an analog voltage. The analog voltage is then converted into a digital signal through the Analog to Digital Converter (ADC) 2023. The control unit 2003 routes the digital signal into the DSP 2005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 2025 for compensation of any frequency-dependent impairments that occur during transmission though the air such as phase and amplitude distortion. After equalizing the bit stream, the modulator 2027 combines the signal with a RF signal generated in the RF interface 2029. The modulator 2027 generates a sine wave by way of frequency or phase modulation. In order to prepare the signal for transmission, an up-converter 2031 combines the sine wave output from the modulator 2027 with another sine wave generated by a synthesizer 2033 to achieve the desired frequency of transmission. The signal is then sent through a PA 2019 to increase the signal to an appropriate power level. In practical systems, the PA 2019 acts as a variable gain amplifier whose gain is controlled by the DSP 2005 from information received from a network base station. The signal is then filtered within the duplexer 2021 and optionally sent to an antenna coupler 2035 to match impedances to provide maximum power transfer. Finally, the signal is transmitted via antenna 2017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 2001 are received via antenna 2017 and immediately amplified by a low noise amplifier (LNA) 2037. A down-converter 2039 lowers the carrier frequency while the demodulator 2041 strips away the RF leaving only a digital bit stream. The signal then goes through the equalizer 2025 and is processed by the DSP 2005. A Digital to Analog Converter (DAC) 2043 converts the signal and the resulting output is transmitted to the user through the speaker 2045, all under control of a Main Control Unit (MCU) 2003 which can be implemented as a Central Processing Unit (CPU).

The MCU 2003 receives various signals including input signals from the keyboard 2047. The keyboard 2047 and/or the MCU 2003 in combination with other user input components (e.g., the microphone 2011) comprise a user interface circuitry for managing user input. The MCU 2003 runs a user interface software to facilitate user control of at least some functions of the mobile terminal 2001 to link one or more virtual gift cards to the wallet database associated with the unique identifier of at least one mobile device. The MCU 2003 also delivers a display command and a switch command to the display 2007 and to the speech output switching controller, respectively. Further, the MCU 2003 exchanges information with the DSP 2005 and can access an optionally incorporated SIM card 2049 and a memory 2051. In addition, the MCU 2003 executes various control functions required of the terminal. The DSP 2005 may, depending upon the implementation, perform any of a variety of conventional digital processing functions on the voice signals. Additionally, DSP 2005 determines the background noise level of the local environment from the signals detected by microphone 2011 and sets the gain of microphone 2011 to a level selected to compensate for the natural tendency of the user of the mobile terminal 2001.

The CODEC 2013 includes the ADC 2023 and DAC 2043. The memory 2051 stores various data including call incoming tone data and is capable of storing other data including music data received via, e.g., the global Internet. The software module could reside in RAM memory, flash memory, registers, or any other form of writable storage medium known in the art. The memory device 2051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 2049 carries, for instance, important information, such as the cellular phone number, the carrier supplying service, subscription details, and security information. The SIM card 2049 serves primarily to identify the mobile terminal 2001 on a radio network. The card 2049 also contains a memory for storing a personal telephone number registry, text messages, and user specific mobile terminal settings.

Further, one or more camera sensors 2053 may be incorporated onto the mobile station 2001 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a request for registering a virtual gift card to a mobile device, wherein the request specifies a unique identifier associated with the mobile device;
determining a card identifier associated with the virtual gift card;
generating a card token for the virtual gift card based on the card identifier; and
storing the card token in a wallet database,
wherein the wallet database is associated with the unique identifier of the mobile device; and
wherein the wallet database is accessed from an application of the mobile device.

2. A method of claim 1, wherein the unique identifier is a MSISDN number, and wherein the card identifier is an EAN-13 barcode.

3. A method of claim 1, further comprising:
receiving a request from the mobile device for an activation of the application to access the wallet database, wherein the request specifies the unique identifier;
initiating a transmission of a security token to the mobile device; and
initiating the activation of the application based on a validated input of the security token entered via the application.

4. A method of claim 3, further comprising:
initiating a transmission of one or more records of the wallet database to populate the application with the virtual gift card,
wherein the one or more records include information associated with the virtual gift car, the card identifier, the card token, or a combination thereof.

5. A method of claim 1, wherein the request for registering the virtual gift card is by at least one of:
a scanning of a physical gift card;
a point-of-sale transaction; and
an input for specifying the virtual gift card, the product identifier, a personal identification number (PIN) of the virtual gift card, or a combination thereof.

6. A method of claim 5, further comprising:
receiving a validation request from a point-of-sale terminal to validate the point-of-sale transaction associated with the virtual gift card;
initiating a validation of the virtual gift card by querying the wallet database to determine a validation response;
transmitting the validation response to the point-of-sale terminal; and
updating the wallet database based on the validation response, the point-of-sale transaction, or a combination thereof to refresh the application of the mobile device.

7. A method of claim 1, further comprising:
generating a short card number to represent the virtual gift card; and
generating a device-specific card number based on the short card number and the unique identifier of the mobile,
wherein the device-specific card number is used for conducting one or more transactions associated with the virtual gift card.

8. A method of claim 1, further comprising:
receiving a share request, a send request, or a combination thereof from the mobile device to share, to send, or a combination thereof the virtual gift card to another mobile device,
wherein for a share request, the wallet database is updated to register the virtual gift card as active for the mobile device and the another mobile device; and
wherein for a send request, the wallet database is updated to register the virtual card as active for the another mobile device and as inactive for the mobile device.

9. A method of claim 8, wherein the share request, the send request, or a combination thereof is initiated via a social networking service, an email service, a messaging service, or a combination thereof.

10. A method of claim 8, wherein the share request, the send request, or combination thereof include one or more criteria for the another mobile device to satisfy before registering the virtual gift card to the another mobile device; and wherein the one or more criteria includes playing a game, completing a task, or a combination thereof associated with the application.

11. An apparatus comprising a processor configured to:
receive a request for registering a virtual gift card to a mobile device, wherein the request specifies a unique identifier associated with the mobile device;
determine a card identifier associated with the virtual gift card;
generate a card token for the virtual gift card based on the card identifier; and
store the card token in a wallet database,
wherein the wallet database is associated with the unique identifier of the mobile device; and
wherein the wallet database is accessed from an application of the mobile device.

12. An apparatus of claim 11, wherein the unique identifier is a MSISDN number, and wherein the card identifier is an EAN-13 barcode.

13. An apparatus of claim 11, further comprising:
receive a request from the mobile device for an activation of the application to access the wallet database, wherein the request specifies the unique identifier;
initiate a transmission of a security token to the mobile device; and
initiate the activation of the application based on a validated input of the security token entered via the application.

14. An apparatus of claim 13, further comprising:
initiate a transmission of one or more records of the wallet database to populate the application with the virtual gift card,
wherein the one or more records include information associated with the virtual gift car, the card identifier, the card token, or a combination thereof.

15. An apparatus of claim 11, wherein the request for registering the virtual gift card is by at least one of:
a scanning of a physical gift card;
a point-of-sale transaction; and
an input for specifying the virtual gift card, the product identifier, a personal identification number (PIN) of the virtual gift card, or a combination thereof.

16. An apparatus of claim 15, further comprising:
receive a validation request from a point-of-sale terminal to validate the point-of-sale transaction associated with the virtual gift card;
initiate a validation of the virtual gift card by querying the wallet database to determine a validation response;
transmit the validation response to the point-of-sale terminal; and
update the wallet database based on the validation response, the point-of-sale transaction, or a combination thereof to refresh the application of the mobile device.

17. An apparatus of claim 11, further comprising:
generate a short card number to represent the virtual gift card; and
generate a device-specific card number based on the short card number and the unique identifier of the mobile,
wherein the device-specific card number is used for conducting one or more transactions associated with the virtual gift card.

18. A computer-readable storage medium carrying one or more sequences of one or more instructions which, when executed by one or more processors, cause an apparatus to at least perform the following steps:
receive a request for registering a virtual gift card to a mobile device, wherein the request specifies a unique identifier associated with the mobile device;
determine a card identifier associated with the virtual gift card;
generate a card token for the virtual gift card based on the card identifier; and
store the card token in a wallet database,
wherein the wallet database is associated with the unique identifier of the mobile device; and
wherein the wallet database is accessed from an application of the mobile device.

19. A computer-readable storage medium of claim 18, wherein the unique identifier is a MSISDN number, and wherein the card identifier is an EAN-13 barcode.

20. A computer-readable storage medium of claim 18, wherein the apparatus is further caused to:
receive a request from the mobile device for an activation of the application to access the wallet database, wherein the request specifies the unique identifier;
initiate a transmission of a security token to the mobile device; and
initiate the activation of the application based on a validated input of the security token entered via the application.
